(19) United States
(12) Patent Application Publication
(10) Pub. No.: US 2026/0128006 A1
(43) Pub. Date: May 7, 2026

(54) DISPLAY PANEL AND DISPLAY DEVICE

(71) Applicant: Tianma Advanced Display Technology Institute (Xiamen) Co., Ltd., Xiamen (CN)

(72) Inventors: Mengmeng Xie, Xiamen (CN); Yuqi Hu, Xiamen (CN)

(73) Assignee: Tianma Advanced Display Technology Institute (Xiamen) Co., Ltd., Xiamen (CN)

(21) Appl. No.: 19/437,405

(22) Filed: Dec. 31, 2025

(30) Foreign Application Priority Data
Jun. 24, 2025 (CN) 202510854838.5

(51) Int. Cl. G09G 3/32

(52) U.S. Cl. CPC G09G 3/32; G09G 2300/0819; G09G 2300/0842; G09G 2310/08

(57) ABSTRACT

A display panel and a display device are provided. The display panel includes: display panel includes: multiple circuit setting regions and multiple light-transmitting regions. The display panel further includes a pixel circuit group located in the circuit setting region, where the pixel circuit group includes at least two pixel circuits, where the at least two pixel circuits include a first pixel circuit and a second pixel circuit, where the first pixel circuit is located on a side of the second pixel circuit close to the light-transmitting region in a first direction. The pixel circuit includes a light-emitting control transistor and an anode reset transistor, the first pixel circuit includes a first light-emitting control transistor and a first anode reset transistor, and the second pixel circuit includes a second light-emitting control transistor.

### CROSS-REFERENCE TO RELATED APPLICATION

This disclosure claims priority to Chinese Patent Application No. 202510854838.5 filed Jun. 24, 2025, the disclosure of which is incorporated herein by reference in its entirety.

### TECHNICAL FIELD

Embodiments of the present disclosure relate to the field of display technology, and in particular, to a display panel and a display device.

### BACKGROUND

With the continuous development of display technology, display panels have been widely used in people's production and daily life. A variety of circuit structures are involved in the display panel, such as pixel circuits, etc., and the overall display effect of the display panel may be guaranteed by the circuit structures.

In order to better meet people's needs, the circuit structure may be finely adjusted to ensure the display effect of the display panel. For example, by adjusting the circuit, the space occupied by the circuit in the display panel may be effectively reduced, thereby providing more setting space, etc., for other structures and improving the overall effect of the display module.

A display panel and a display device are provided according to embodiments of the present disclosure, with which, by adjusting the setting position of the transistors in the pixel circuit groups, the pixel circuit groups may be guaranteed to be more compact, and the occupied area of the pixel circuit region may be reduced.

In a first aspect, a display panel is provided according to embodiments of the present disclosure, which includes: multiple circuit setting regions and multiple light-transmitting regions, where the circuit setting region partially surrounds the light-transmitting region. The display panel further includes a pixel circuit group located in the circuit setting region, where the pixel circuit group includes at least two pixel circuits, where the at least two pixel circuits include a first pixel circuit and a second pixel circuit, where the first pixel circuit is located on a side of the second pixel circuit close to the light-transmitting region in a first direction. The pixel circuit includes a light-emitting control transistor and an anode reset transistor, the first pixel circuit includes a first light-emitting control transistor and a first anode reset transistor, and the second pixel circuit includes a second light-emitting control transistor. In the same pixel circuit group, the first anode reset transistor is located on a side of the first light-emitting control transistor close to the second light-emitting control transistor in the first direction.

In a second aspect, based on the same inventive concept, a display device is provided according to embodiments of the present disclosure, which includes a display panel. The display panel includes: multiple circuit setting regions and multiple light-transmitting regions, where the circuit setting region partially surrounds the light-transmitting region. The display panel further includes a pixel circuit group located in the circuit setting region, where the pixel circuit group includes at least two pixel circuits, where the at least two pixel circuits include a first pixel circuit and a second pixel circuit, where the first pixel circuit is located on a side of the second pixel circuit close to the light-transmitting region in a first direction. The pixel circuit includes a light-emitting control transistor and an anode reset transistor, the first pixel circuit includes a first light-emitting control transistor and a first anode reset transistor, and the second pixel circuit includes a second light-emitting control transistor. In the same pixel circuit group, the first anode reset transistor is located on a side of the first light-emitting control transistor close to the second light-emitting control transistor in the first direction.

It should be understood that the contents described in this portion are not intended to identify the key or important features of the embodiments of the present disclosure, nor are they intended to limit the scope of the present disclosure. Other features of the present disclosure will become easier to understand through the following description.

### BRIEF DESCRIPTION OF DRAWINGS

To more clearly illustrate the technical solution of the exemplary embodiment of the present disclosure, the following is a brief introduction to the drawings required to describe the embodiments. The drawings introduced are only drawings of some embodiments to be described in the present disclosure, not drawings of all embodiments. For the person of ordinary skills in the art, other drawings may be obtained based on these drawings without making creative efforts.

FIG. 1 is a schematic structural diagram of a first display panel provided in an embodiment of the present disclosure;

FIG. 2 is a schematic circuit diagram of a pixel circuit provided in an embodiment of the present disclosure;

FIG. 3 is a timing diagram of an implementation of signals provided to the pixel circuit shown in FIG. 2 within a driving cycle provided in an embodiment of the present disclosure;

FIG. 4 is a schematic diagram of a film layer structure of the pixel circuit shown in FIG. 2;

FIG. 5 is a schematic cross-sectional view of a pixel circuit provided in an embodiment of the present disclosure;

FIG. 6 is a schematic diagram of a film layer registered structure of a display panel provided in an embodiment of the present disclosure;

FIG. 7 is a schematic diagram of a first part structure in FIG. 6;

FIG. 8 is a schematic diagram of a second part structure in FIG. 6;

FIG. 9 is a schematic diagram of a third part structure in FIG. 6;

FIG. 10 is a schematic diagram of a fourth part structure in FIG. 6;

FIG. 11 is a schematic diagram of a fifth part structure in FIG. 6;

FIG. 12 is a schematic diagram of a sixth part structure in FIG. 6;

FIG. 13 is a schematic diagram of a seventh part structure in FIG. 6;

FIG. 14 is a schematic diagram showing the stacking of the second part structure and the third part structure in FIG. 6;

FIG. 15 is a schematic diagram showing the stacking of part structures in FIG. 6;

FIG. 16 is a schematic diagram showing the stacking of the third part structure and the fourth part structure in FIG. 6;

FIG. 17 is a schematic diagram showing the stacking of the third part structure and the fifth part structure in FIG. 6;

FIG. 18 is a schematic diagram showing the stacking of the fourth part structure and the fifth part structure in FIG. 6;

FIG. 19 is a schematic diagram showing the stacking of the second part structure and the fifth part structure in FIG. 6;

FIG. 20 is an enlarged schematic diagram of an anode reset connection portion provided in an embodiment of the present disclosure;

FIG. 21 is a schematic diagram of another fifth part structure in FIG. 6;

FIG. 22 is a schematic diagram of yet another fifth part structure in FIG. 6;

FIG. 23 is a schematic diagram showing the stacking of the first part structure and the second part structure in FIG. 6;

FIG. 24 is a schematic diagram showing the stacking of the first part structure, the second part structure, and the fifth part structure in FIG. 6;

FIG. 25 is a schematic diagram of a film layer structure of another display panel provided in an embodiment of the present disclosure;

FIG. 26 is a schematic diagram showing the stacking of the sixth part structure and the seventh part structure in FIG. 6;

FIG. 27 is a schematic structural diagram of a second display panel provided in an embodiment of the present disclosure;

FIG. 28 is a schematic structural diagram of a first temperature-sensing partition provided in an embodiment of the present disclosure;

FIG. 29 is a schematic structural diagram of a third display panel provided in an embodiment of the present disclosure;

FIG. 30 is a schematic structural diagram of a second temperature-sensing sub-region provided in an embodiment of the present disclosure;

FIG. 31 is a schematic structural diagram of a third temperature-sensing sub-region provided in an embodiment of the present disclosure;

FIG. 32 is a first schematic diagram of the A-A’ section in FIG. 28;

FIG. 33 is a second schematic diagram of the A-A’ section in FIG. 28;

FIG. 34 is a schematic structural diagram of a fourth display panel provided in an embodiment of the present disclosure;

FIG. 35 is a schematic diagram showing a partial structure of a display panel provided in an embodiment of the present disclosure; and

FIG. 36 is a schematic structural diagram of a display device provided in an embodiment of the present disclosure.

### DETAILED DESCRIPTION

The present disclosure is further described in detail below in conjunction with the drawings and embodiments. It may be understood that the embodiments described herein are only intended to explain the present disclosure, not to limit the present disclosure. It should also be noted that, for the convenience of description, only part of the structure related to the present disclosure, rather than all of it, is shown in the drawings.

It should be noted that the terms "first", "second", etc., in the specification and claims of the present disclosure and the above-mentioned drawings are intended to distinguish similar objects, and are not necessarily used to describe a specific order or sequence. It should be understood that the data used in this way may be interchanged where appropriate, so that the embodiments of the present disclosure described here may be implemented in an order other than those illustrated or described here. Furthermore, the terms "including" and "having" and any of their variations are intended to cover non-exclusive inclusions, for example, a system, product or device containing a series of units is not necessarily limited to those steps or units clearly listed, but may include other units that are not clearly listed or inherent to these products or devices.

It is obvious to the person skilled in the art that various modifications and changes may be made in the present disclosure without departing from the spirit or scope of the present disclosure. Therefore, the present disclosure is intended to cover modifications and changes of the present disclosure that fall within the scope of the corresponding claims (technical solutions claimed for protection) and their equivalents. It should be noted that the implementations provided by the embodiments of the present disclosure may be combined without contradiction.

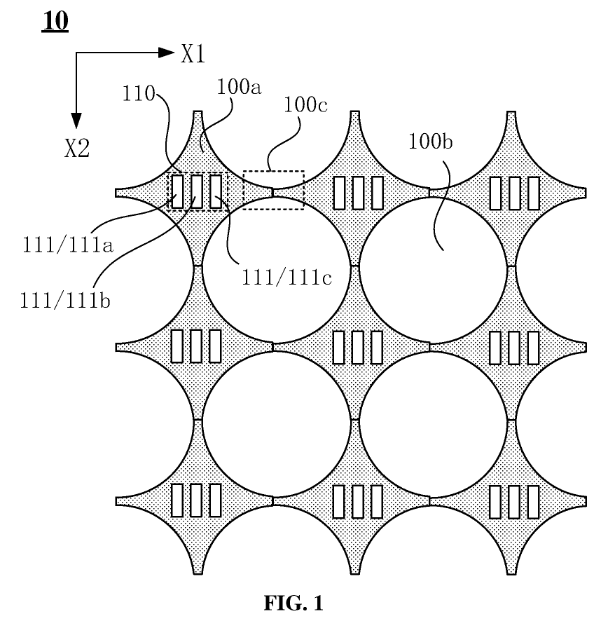

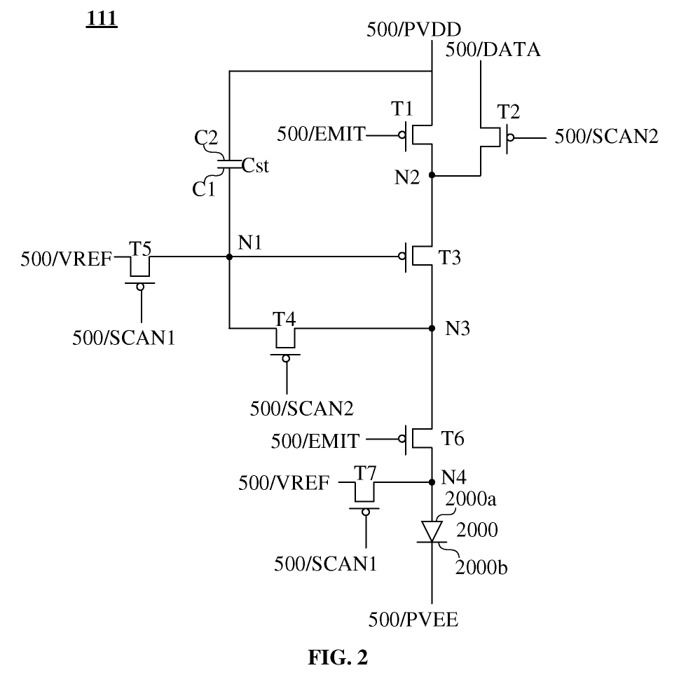

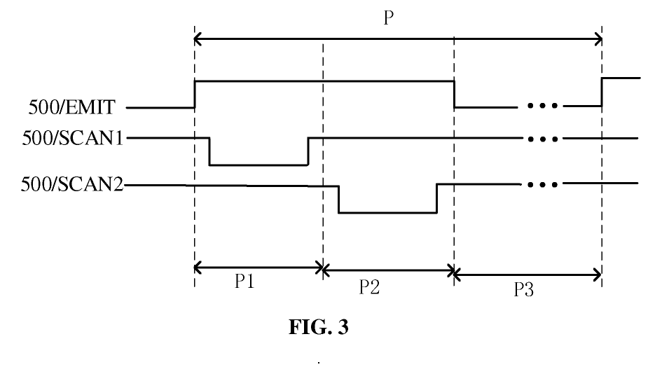

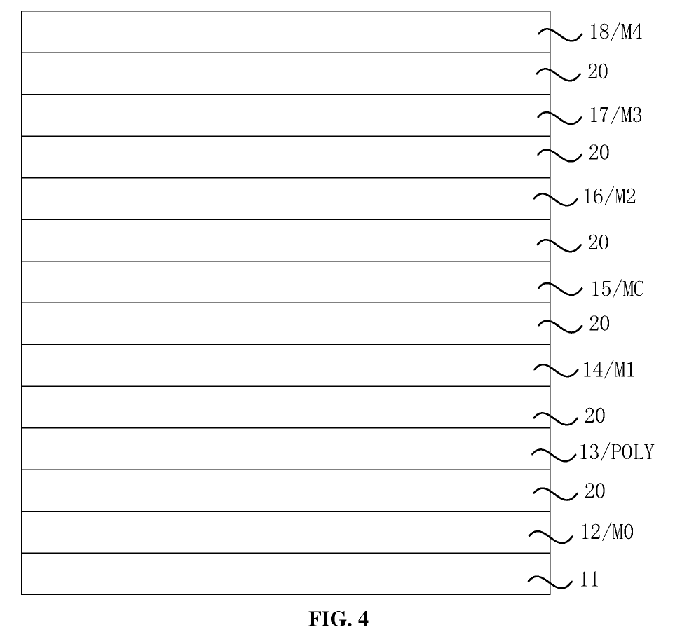

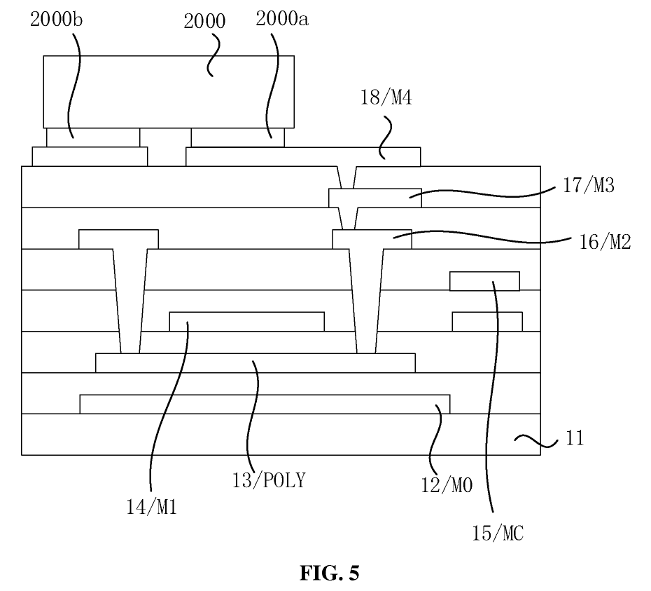

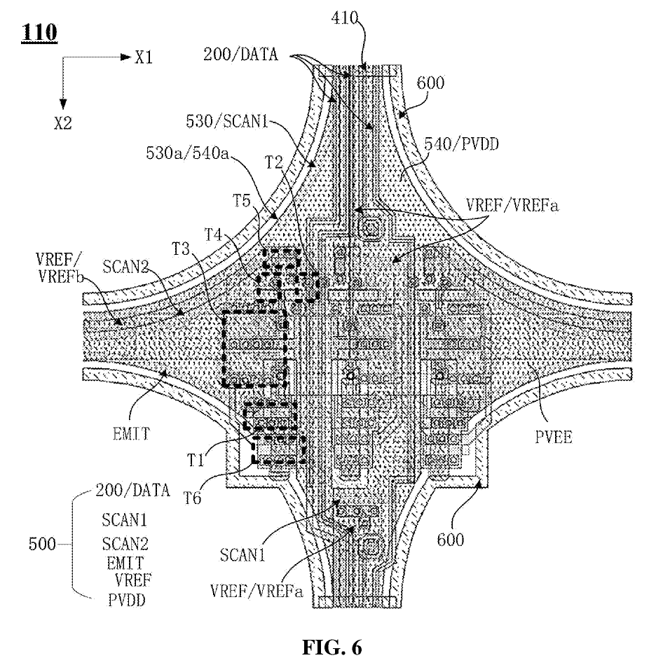

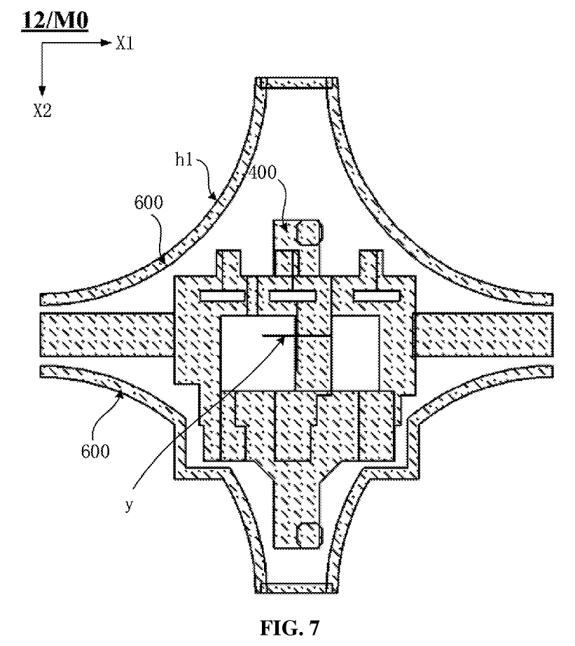

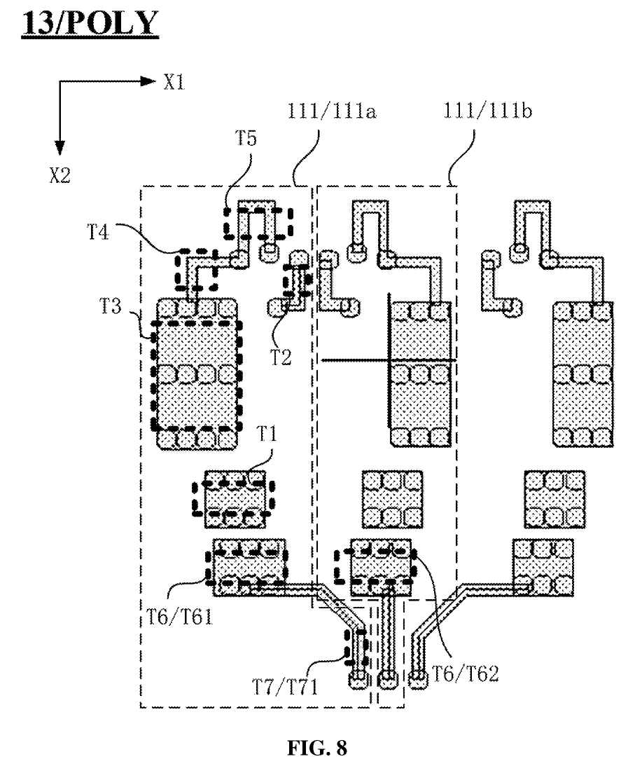

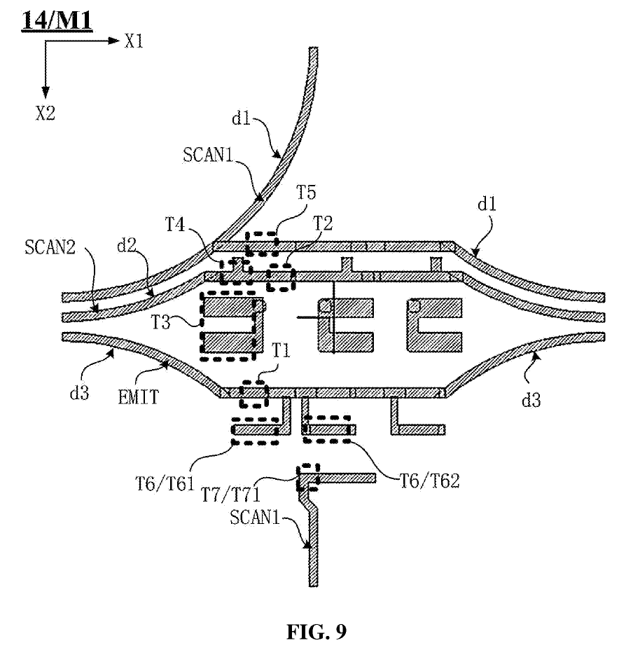

FIG. 1 is a schematic structural diagram of a first display panel provided in an embodiment of the present disclosure; FIG. 2 is a schematic circuit diagram of a pixel circuit provided in an embodiment of the present disclosure; FIG. 3 is a timing diagram of an implementation of a signal provided to the pixel circuit shown in FIG. 2 within a driving cycle provided in an embodiment of the present disclosure; FIG. 4 is a schematic diagram of a film layer structure of the pixel circuit shown in FIG. 2; FIG. 5 is a schematic cross-sectional view of a pixel circuit provided in an embodiment of the present disclosure; FIG. 6 is a schematic diagram of a film layer registered structure of a display panel provided in an embodiment of the present disclosure; FIG. 7 is a schematic diagram of a first part structure in FIG. 6; FIG. 8 is a schematic diagram of a second part structure in FIG. 6; and FIG. 9 is a schematic diagram of a third part structure in FIG. 6. Referring to FIG. 1 to FIG. 9, a display panel 10 is provided according to an embodiment of the present disclosure, which includes: multiple circuit setting regions 100a and multiple light-transmitting regions 100b, and the circuit setting region 100a partially surrounds the light-transmitting region 100b. The display panel 10 further includes a pixel circuit group 110 located in the circuit setting region 100a, the pixel circuit group 110 includes at least two pixel circuits 111, and the at least two pixel circuits 111 include a first pixel circuit 111a and a second pixel circuit 111b. The first pixel circuit 111a is located on a side of the second pixel circuit 111b close to the light-transmitting region 100b in a first direction X1. The pixel circuit 111 includes a light-emitting control transistor T6 and an anode reset transistor T7. The first pixel circuit 111a includes a first light-emitting control transistor T61 and a first anode reset transistor T71, and the second pixel circuit 111b includes a second light-emitting control transistor T62. In the same pixel circuit group 110, the first anode reset transistor T71 is located on a side of the first light-emitting control transistor T61 close to the second light-emitting control transistor T62 in the first direction X1.

In one or more embodiments, as shown in FIG. 1, the display panel 10 includes multiple circuit setting regions 100a. In one or more embodiments, the circuit setting region 100a is configured to set a circuit structure, and the circuit structure may be a pixel circuit or a driving circuit, etc. The circuit structure set in the circuit setting region 100a is configured to realize the display function of the display panel 10 by providing relevant signals to a light-emitting element (not specifically shown in the figure). The display panel 10 further includes multiple light-transmitting regions 100b, the film layer structure set at the light-transmitting region 100b has a high transmittance or no film layer structure is set at the light-transmitting region 100b, and the light-transmitting region 100b combined with the circuit setting region 100a can realize the transparent display effect of the display panel 10. The circuit setting region 100a in the display panel 10 partially surrounds the light-transmitting region 100b, regarding this, the circuit setting regions 100a may completely surround the light-transmitting region 100b, or the circuit setting region 100a may surround part of the light-transmitting region 100b. In one or more embodiments, as shown in FIG. 1, the circuit setting region 100a may be set between two adjacent light-transmitting regions 100b, and the specific setting positions of the circuit setting region 100a and the light-transmitting region 100b may be adaptively adjusted according to practical requirements.

In one or more embodiments, as shown in FIG. 1, the circuit setting region 100a includes a pixel circuit group 110, and the pixel circuit group 110 includes a pixel circuit 111. The pixel circuit 111 is electrically connected to a light-emitting element, and the pixel circuit 111 can drive the light-emitting element to perform light-emitting display, thereby realizing the overall display effect of the display panel 10. In one or more embodiments, the pixel circuit group 110 includes at least two pixel circuits 111, and different pixel circuits 111 may be electrically connected to light-emitting elements of different colors, thereby realizing the color display effect of the display panel 10.

In one or more embodiments, the setting methods of the pixel circuit 111are diverse. In one or more embodiments, as shown in FIG. 2, the pixel circuit 111 is illustrated by taking "7T1C" as an example, where "T" represents a transistor and "C" represents a capacitor. Further, referring to FIG. 2, the transistors in the figures are all low-temperature poly-silicon (LTPS) transistors, which have the advantages of high switching speed, high carrier mobility, and low power. In other embodiments, some transistors may also be indium gallium zinc oxide (IGZO) transistors, which have the advantages of low leakage current. Based on the setting mode of the pixel circuit 111, the person skilled in the art can make adaptive adjustments according to requirements, such as increasing or decreasing the number of transistors, or adjusting the type of transistors, etc.

In one or more embodiments, as shown in FIG. 2, the pixel circuit 111 further includes a power signal writing transistor T1, a data writing transistor T2, a driving transistor T3, a threshold compensation transistor T4, and an initialization transistor T5. The display panel 10 further includes a first scanning signal line SCAN1, a second scanning signal line SCAN2, a light-emitting control signal line EMIT, a reset signal line VREF, a data signal line DATA, a first power signal line PVDD, and a second power signal line PVEE. The display panel 10 further includes a light-emitting element 2000, and the light-emitting element includes a first electrode 2000a and a second electrode 2000b. A first terminal of the power signal writing transistor T1 and a second electrode plate C2 are both electrically connected to the first power signal line PVDD, a second terminal of the power signal writing transistor T1 is connected to a first terminal of the driving transistor T3, and a control terminal of the power signal writing transistor T1 is electrically connected to the light-emitting control signal line EMIT. A first terminal of the data writing transistor T2 is electrically connected to the data signal line DATA, a second terminal of the data writing transistor T2 is connected to the first terminal of the driving transistor T3, and a control terminal of the data writing transistor T2 is electrically connected to the second scanning signal line SCAN2. A second terminal of the driving transistor T3 is electrically connected to each of a first terminal of the threshold compensation transistor T4 and a first terminal of the light-emitting control transistor T6, and a control terminal of the driving transistor T3 is electrically connected to a second terminal of the threshold compensation transistor T4, a first terminal of the initialization transistor T5 and a first electrode plate C1. A control terminal of the threshold compensation transistor T4 is electrically connected to the second scanning signal line SCAN2. A second terminal of the initialization transistor T5 and a first terminal of the anode reset transistor T7 are both electrically connected to the reset signal line VREF, and a control terminal of the initialization transistor T5 and a control terminal of the anode reset transistor T7 are both electrically connected to the first scanning signal line SCAN1. A second terminal of the anode reset transistor T7 and a second terminal of the light-emitting control transistor T6 are both electrically connected to the first electrode 2000a, and a control terminal of the light-emitting control transistor T6 is electrically connected to the light-emitting control signal line EMIT. The second electrode 2000b is electrically connected to the second power signal line PVEE.

With reference to FIG. 2, the embodiment of the present application is illustrated by an example in which the transistors in the pixel circuit 111are all low-temperature poly-silicon transistors. FIG. 3 is a timing diagram of an implementation of signals provided to the pixel circuit shown in FIG. 2 within a driving cycle provided in an embodiment of the present disclosure. With reference to FIG. 2 and FIG. 3, the first scanning signal line SCAN1, connected to the control terminal of the initialization transistor T5, can control the on and off of the initialization transistor T5, and when the initialization transistor T5 is turned on, the first scanning signal line SCAN1 writes a reset signal in the reset signal line VREF, electrically connected to the second terminal of the initialization transistor T5, to the control terminal of the driving transistor T3, so that a first node N1 may be reset. A storage capacitor Cst provided includes the first electrode plate C1 and the second electrode plate C2, specifically, the first electrode plate C1 is connected to the first terminal of the initialization transistor T5, and the storage capacitor Cst can ensure a stable potential of the first node N1. The second scanning signal line SCAN2, connected to the control terminal of the data writing transistor T2, can control the on and off of the data writing transistor T2, and when the data writing transistor T2 is turned on, the second scanning signal line SCAN2 writes a data signal in the data signal line DATA, electrically connected to the first terminal of the data writing transistor T2, to the first terminal of the driving transistor T3, that is, the second terminal of the data writing transistor T2 is connected to the first terminal of the driving transistor T3 at a second node N2. The second scanning signal line SCAN2, connected to the control terminal of the threshold compensation transistor T4, can control the on and off of the threshold compensation transistor T4, and perform threshold voltage compensation on the driving transistor T3 when the threshold compensation transistor T4 is turned on. Moreover, the first scanning signal line SCAN1, connected to the control terminal of the anode reset transistor T7, can control the on and off of the anode reset transistor T7, and when the anode reset transistor T7 is turned on, the first scanning signal line SCAN1 writes the reset signal in the reset signal line VREF, electrically connected to the first terminal of the anode reset transistor T7, to the first electrode 2000a of the light-emitting element 2000, that is, a fourth node N4, to reset the light-emitting element 2000. The light-emitting control signal line EMIT, connected to the control terminal of the power signal writing transistor T1 and the control terminal of the light-emitting control transistor T6, can control the on and off of the power signal writing transistor T1 and the light-emitting control transistor T6, and when the power signal writing transistor T1 and the light-emitting control transistor T6 are turned on, the light-emitting control signal line EMIT writes a signal in the first power signal line PVDD to the driving transistor T3, and the driving current generated by the driving transistor T3 is transmitted to the light-emitting element 2000, to realize the display and light emission of the light-emitting element 2000.

In one or more embodiments, referring to FIG. 3, a frame time of the display panel 10 includes at least an initialization stage P1, a data writing stage P2, and a light emitting stage P3. In the initialization stage P1, the initialization transistor T5 is turned on under the control of the first scanning signal line SCAN1, and the reset signal in the reset signal line VREF is written to the first node N1, electrically connected to the control terminal of the driving transistor T3, to initialize the control terminal of the driving transistor T3. At the same time, since the threshold compensation transistor T4 is turned on, the reset signal in the reset signal line VREF is also written to the second terminal of the driving transistor T3, that is, the N3 node. In the data writing stage P2, the data writing transistor T2 is turned on under the control of the second scanning signal line SCAN2, and the threshold compensation transistor T4 is turned on under the control of the second scanning signal line SCAN2, so that the signal in the data signal line DATA is written to the control terminal of the driving transistor T3 through sequentially the data writing transistor T2, the driving transistor T3 and the threshold compensation transistor T4. At the same time, in the data writing stage P2, the anode reset transistor T7 is turned on under the control of the first scanning signal line SCAN1, and writes the reset signal in the reset signal line VREF into the first electrode 2000a of the light-emitting element 2000, to initialize the first electrode 2000a of the light-emitting element 2000. In the light-emitting stage P3, the power signal writing transistor T1 and the light-emitting control transistor T6 are turned on under the control of the light-emitting control signal line EMIT, so that the driving transistor T3 generates a driving current that may be transmitted to the light-emitting element 2000, thereby driving the light-emitting element 2000 to emit light.

Further, referring to FIGS. 4 and 5, the display panel 10 is configured by overlapping multiple film layers. The film layer structure of the pixel circuit 111 shown in FIG. 4 may correspond to the pixel circuit 111 provided in FIG. 2. In one or more embodiments, with reference to FIG. 4 and FIG. 5, the film layer structure of the pixel circuit 111 is arranged on one side of a substrate 11, and from the substrate 11 to a light-emitting side of the display panel 10, a light-shielding metal layer 12, a first semiconductor layer 13, a first metal layer 14, a second metal layer 15, a third metal layer 16, a fourth metal layer 17, and a fifth metal layer 18 may be sequentially arranged, and insulating layers 20 are arranged between the above film layers. In one or more embodiments, with reference to FIG. 4 and FIG. 5, the light-shielding metal layer 12 may be understood as an M0 layer in the display panel 10, the first metal layer 14 may be understood as an M1 layer in the display panel 10, the second metal layer 15 may be understood as an MC layer in the display panel 10, the third metal layer 16 may be understood as an M2 layer in the display panel 10, the fourth metal layer 17 may be understood as an M3 layer in the display panel 10, and the fifth metal layer 18 may be understood as an M4 layer in the display panel 10. It should be noted that FIG. 5 shows a cross-sectional view of a transistor in the pixel circuit 111as an example for illustration, and does not show all transistors in the pixel circuit 111. The film layer structure of the specific pixel circuit 111 may be adaptively adjusted according to practical requirements, such as adding or removing some film layers, and any of the above film layers may include at least one sublayer, which is not specifically limited in the embodiment of the present disclosure.

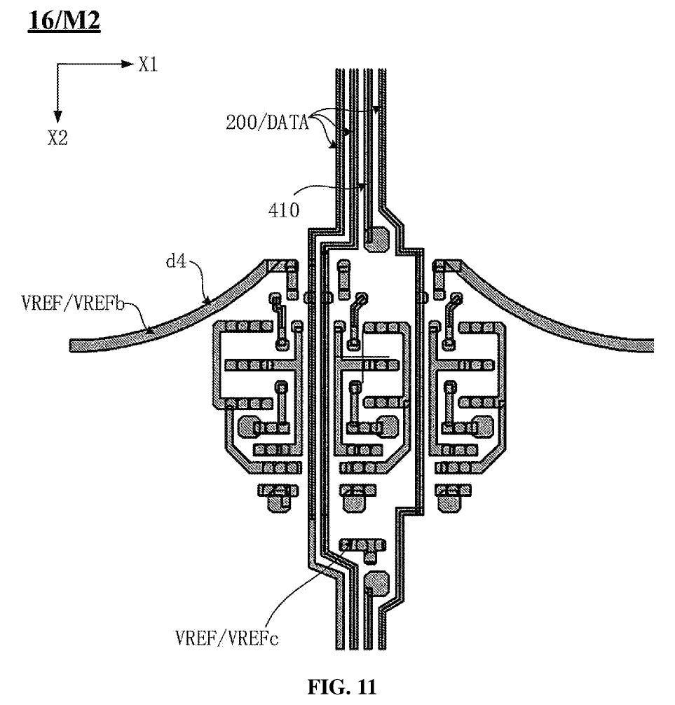

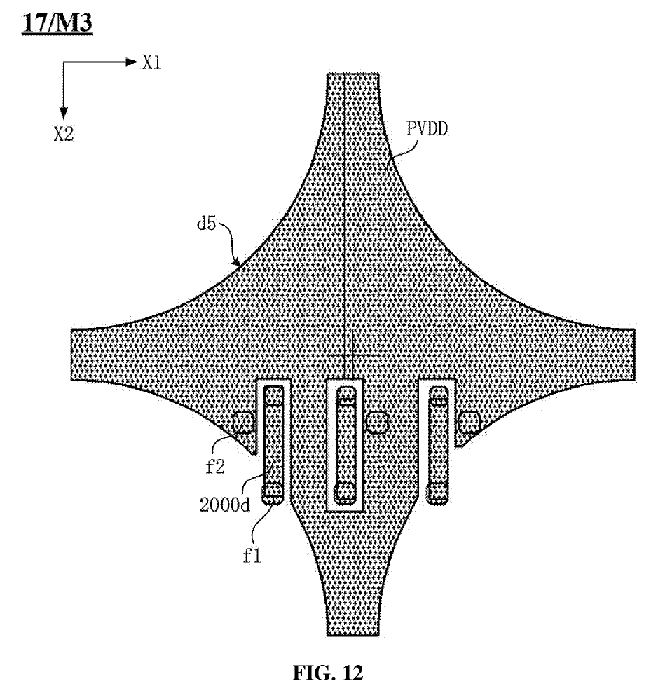

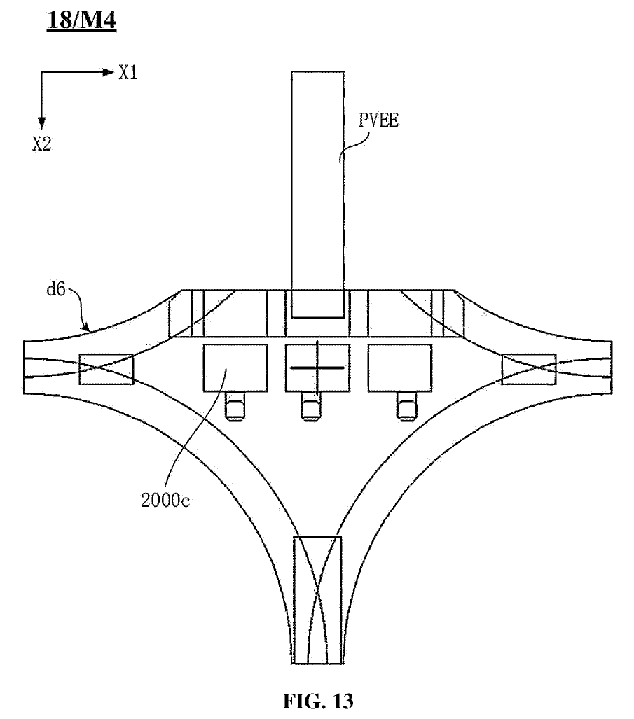

FIG. 11 is a schematic diagram of a fifth part structure in FIG. 6, FIG. 12 is a schematic diagram of a sixth part structure in FIG. 6, and FIG. 13 is a schematic diagram of a seventh part structure in FIG. 6. Referring to FIG. 6 to FIG. 13, if the pixel circuit 111 in the display panel 10 is the pixel circuit 111 shown in FIG. 2, reference may be made to FIG. 6 for the registration relationships between the film layers in the film layer registered structure of the display panel 10, and FIG. 7 to FIG. 13 are used to illustrate the different film layers in FIG. 6 from bottom to top. The film layers shown in FIG. 7 to FIG. 13 may be arranged in the film layers shown in FIG. 4 and FIG. 5, and the subsequent instructions will explain the arrangements of the film layers of the part structures.

It should be noted that FIG. 6 to FIG. 13 all include a "cross" mark, specifically referring to the mark y in FIG. 7, the mark is used for alignment and has no practical meaning. The mark will not be explained repeatedly when appearing in the subsequent film layer diagrams.

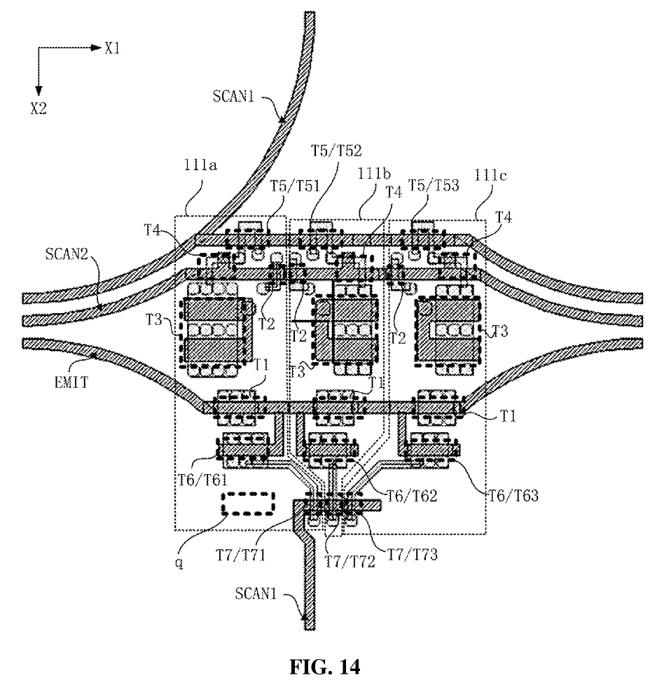

Further, FIG. 14 is a schematic diagram showing the stacking of the second part structure and the third part structure in FIG. 6. The pixel circuit group 110 includes multiple pixel circuits 111. Different pixel circuits 111 may be connected to light-emitting elements of different colors to achieve a color display effect of the display panel 10. FIG. 14 shows the first pixel circuit 111a and the second pixel circuit 111b in the film layer structure. The first pixel circuit 111a and the second pixel circuit 111b each include the light-emitting control transistor T6 and the anode reset transistor T7. The positions of the light-emitting control transistors T6 and the anode reset transistors T7 may be adjusted to ensure that the overall space occupied by the first pixel circuit 111a and the second pixel circuit 111b is more compact.

In one or more embodiments, referring to FIG. 14, the first pixel circuit 111a includes a first light-emitting control transistor T61 and a first anode reset transistor T71, and the second pixel circuit 111b includes a second light-emitting control transistor T62. FIG. 14 shows the positional relationship between the first pixel circuit 111a and the second pixel circuit 111b in a pixel circuit group 110. In the same pixel circuit group 110 and in the first direction X1, the first anode reset transistor T71 is located on the side of the first light-emitting control transistor T61, close to the second light-emitting control transistor T62. In other words, in the first direction X1, the minimum distance between the first light-emitting control transistor T61 and the first anode reset transistor T71 is greater than the minimum distance between the second light-emitting control transistor T62 and the first anode reset transistor T71. By arranging the first anode reset transistor T71 in the first pixel circuit 111a close to the second pixel circuit 111b, that is, arranging the first anode reset transistor T71 in the first pixel circuit 111a in the pixel circuit group 110 closer to the central region, the pixel circuit group 110 including the first pixel circuit 111a arranged in this way can avoid more space. Then, the space avoided by the first anode reset transistor T71 is provided to other structures or other regions of the display panel 10. In one or more embodiments, the space avoided by the first pixel circuit 111a is set as the light-transmitting region 100b, which can improve the overall light transmittance of the display panel 10.

In this way, the first pixel circuit 111a and the second pixel circuit 111b are arranged more compactly, and the space occupied by the pixel circuit group 110 as a whole is smaller, providing more abundant setting space for other structures or other regions of the display panel 10, and improving the overall functionality of the display panel.

In one or more embodiments, the first pixel circuit 111a may be connected to a red light-emitting element or a blue light-emitting element, and the second pixel circuit 111b may be connected to a green light-emitting element. The specific connection of the light-emitting elements to the first pixel circuit 111a and the second pixel circuit 111b may be adaptively adjusted according to practical requirements.

It should be noted that, taking the orientation shown in FIG. 14 as an example, FIG. 14 only takes the first pixel circuit 111a located on the left side of the second pixel circuit 111b as an example for explanation. It may be understood that the first pixel circuit 111a may also be located on the right side of the second pixel circuit 111b. In the embodiment of the present disclosure, the specific orientation relationship between the first pixel circuit 111a and the second pixel circuit 111b is not limited, as long as the first pixel circuit 111a is set to be located on the side of the second pixel circuit 111b close to the light-transmitting region 100b.

In summary, in the display panel provided according to embodiments of the present disclosure, in the pixel circuit group, the first pixel circuit is located in an edge region of the circuit setting region compared with the second pixel circuit, and the second pixel circuit is located in the middle region of the circuit setting region compared with the first pixel circuit. In the same pixel circuit group, in the direction from the first pixel circuit to the second pixel circuit, the first anode reset transistor is located on the side of the first light-emitting control transistor close to the second light-emitting control transistor, so that the first pixel circuit and the second pixel circuit are arranged more compactly, and the overall occupied space is smaller, providing more abundant setting space for other structures or other regions of the display panel, and improving the overall functionality of the display panel.

Further, the position adjustment of the transistors in the first pixel circuit and the transistors in the second pixel circuit may be as follows.

In one or more embodiments, referring to FIG. 1, FIG. 6, and FIG. 14, the first anode reset transistor T71 and the first light-emitting control transistor T61 do not overlap in a second direction X2. The second direction X2 intersects the first direction X1.

In one or more embodiments, referring to FIG. 14, FIG. 14 shows the setting positions of the transistors in the first pixel circuit 111a and the setting positions of the transistors in the second pixel circuit 111b. FIG. 14, by showing the channel regions corresponding to the transistors, shows the setting positions of the corresponding transistors, specifically, for a transistor, the active layer of the transistor is set in the first semiconductor layer 13, the control terminal of the transistor (the gate of the transistor) is set in the first metal layer 14, and the overlapping region of the control terminal and the active layer is the channel region of the transistor.

Further, referring to FIG. 14, in the second direction X2, the first anode reset transistor T71 and the first light-emitting control transistor T61 do not overlap; that is, in the second direction X2, the first anode reset transistor T71 and the first light-emitting control transistor T61 are staggered. Since the first anode reset transistor T71 is closer to the second pixel circuit 111b, it may be understood that in the first direction X1, the first anode reset transistor T71 in the first pixel circuit 111a is set closer to the central region of the pixel circuit group 110. Compared with setting the first light-emitting control transistor T61 in the region where it overlaps the first anode reset transistor T71, more space may be saved (refer to a region q in FIG. 14). The saved space of the display panel 10 may be set as a light-transmitting region 100b to increase the overall light transmittance of the display panel 10.

In one or more embodiments, the first pixel circuit 111a may be electrically connected to a red light-emitting element or a blue light-emitting element, and the second pixel circuit 111b may be electrically connected to a green light-emitting element. In this way, in the second direction X2, the anode reset transistor T7 in the pixel circuit 111 electrically connected to the red light-emitting element or the blue light-emitting element and the light-emitting control transistor T6 in the pixel circuit 111 electrically connected to the red light-emitting element or the blue light-emitting element are arranged not to overlap.

In one or more embodiments, referring to FIG. 1, FIG. 6, and FIG. 14, in the same pixel circuit group 110, the first anode reset transistor T71 overlaps the second light-emitting control transistor T62 in the second direction X2. The second direction X2 intersects the first direction X1.

Further, referring to FIG. 14, in the second direction X2, and in the same pixel circuit group 110, the first anode reset transistor T71 and the second light-emitting control transistor T62 are at least partially overlapped, that is, the setting position of the first anode reset transistor T71 in the first pixel circuit 111a extends to the overall setting region of the second pixel circuit 111b.

In one or more embodiments, referring to FIG. 14, the second light-emitting control transistor T62 is located in the second pixel circuit 111b, and the orthographic projection of the second light-emitting control transistor T62 in the second direction X2 overlaps the orthographic projection of the first anode reset transistor T71 in the second direction X2. Adjusting the first anode reset transistor T71 close to the second light-emitting control transistor T62 can ensure that space is reserved in the first pixel circuit 111a (refer to the region q in FIG. 14). The saved space of the display panel 10 may be set as a light-transmitting region 100b to increase the overall light transmittance of the display panel 10.

In one or more embodiments, the first pixel circuit 111a may be electrically connected to the red light-emitting element or the blue light-emitting element, and the second pixel circuit 111b may be electrically connected to the green light-emitting element. In this way, in the second direction X2, the anode reset transistor T7 in the pixel circuit 111 electrically connected to the red light-emitting element or the blue light-emitting element and the anode reset transistor T7 in the pixel circuit 111 electrically connected to the green light-emitting element are arranged to overlap.

Continuing with reference to 1, FIG. 6 and FIG. 14, the at least two pixel circuits 111 further include a third pixel circuit 111c, and the first pixel circuit 111a, the second pixel circuit 111b and the third pixel circuit 111c are arranged in the first direction X1. The third pixel circuit 111c includes a third light-emitting control transistor T63 and a third anode reset transistor T73. In the same pixel circuit group 110, in the first direction X1, the third anode reset transistor T73 is located on the side of the third light-emitting control transistor T63 close to the second light-emitting control transistor T62.

In one or more embodiments, referring to FIG. 1 and FIG. 14, the pixel circuit group 110 may include a first pixel circuit 111a, a second pixel circuit 111b, and a third pixel circuit 111c, and the first pixel circuit 111a, the second pixel circuit 111b, and the third pixel circuit 111c are arranged in the first direction X1. In other words, in the pixel circuit group 110, the first pixel circuit 111a and the third pixel circuit 111c are closer to the edge and closer to the light-transmitting region 100b, while the second pixel unit 111b is closer to the central region, is farther from the light-transmitting region 100b than the first pixel circuit 111a is, and is farther from the light-transmitting region 100b than the third pixel circuit 111c is.

In one or more embodiments, referring to FIG. 14, for the pixel circuit group 110, the arrangement of transistors in the first pixel circuit 111a and the arrangement of transistors in the third pixel circuit 111c may be mirror-symmetrical with respect to the second pixel circuit 111b. The arrangement of transistors in the second pixel circuit 111b may be the same as the arrangement of transistors in the first pixel circuit 111a, or the arrangement of transistors in the second pixel circuit 111b may be the same as the arrangement of transistors in the third pixel circuit 111c. In FIG. 14, an example is given for illustration in which the arrangement of transistors in the second pixel circuit 111b is the same as the arrangement of transistors in the third pixel circuit 111c. For example, in the pixel circuit group 110, the first pixel circuit 111a is connected to a red light-emitting element, the second pixel circuit 111b is connected to a green light-emitting element, and the third pixel circuit 111c is connected to a blue light-emitting element; or in the pixel circuit group 110, the first pixel circuit 111a is connected to a blue light-emitting element, the second pixel circuit 111b is connected to a green light-emitting element, and the third pixel circuit 111c is connected to a red light-emitting element.

Further, as shown in FIG. 14, the third pixel circuit 111c includes a third light-emitting control transistor T63 and a third anode reset transistor T73. In the same pixel circuit group 110, and in the first direction X1, the third anode reset transistor T73 is located on the side of the third light-emitting control transistor T63 close to the second light-emitting control transistor T62. In other words, in the first direction X1, the minimum distance between the third light-emitting control transistor T63 and the third anode reset transistor T73 is greater than the minimum distance between the second light-emitting control transistor T62 and the third anode reset transistor T73. By setting the third anode reset transistor T73 in the third pixel circuit 111c close to the second pixel circuit 111b, that is, by setting the position of the third anode reset transistor T73 in the third pixel circuit 111c in the pixel circuit group 110 to be closer to the central region in the first direction X1, the pixel circuit group 110 including the third pixel circuit 111c arranged as such can avoid more space. Then, the space avoided by the third anode reset transistor T73 is provided to other structures or other regions of the display panel 10. In one or more embodiments, the space avoided by the third pixel circuit 111c is set as the light-transmitting region 100b, which can improve the overall light transmittance of the display panel 10.

Further, referring to FIG. 14, the third anode reset transistor T73 and the third light-emitting control transistor T63 do not overlap in the second direction X2; that is, the third anode reset transistor T73 and the third light-emitting control transistor T63 are staggered in the second direction X2. Moreover, in the same pixel circuit group 110, the third anode reset transistor T73 overlaps the second light-emitting control transistor T62 in the second direction X2.

It should be noted that the first pixel circuit 111a and the third pixel circuit 111c are both located at the edge region of the circuit setting region compared with the second pixel circuit 111b. With reference to FIG. 14, it is equivalent to setting the first anode reset transistor T71 in the first pixel circuit 111a and the third anode reset transistor T73 in the third pixel circuit 111c close to the second pixel circuit 111b, which can further reduce the occupied space of the circuit setting region 100a.

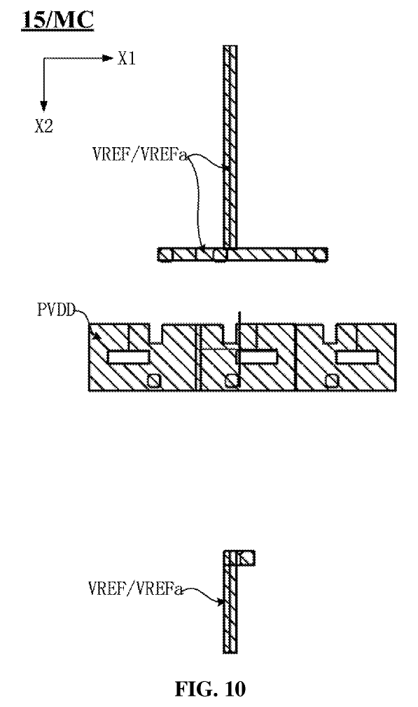

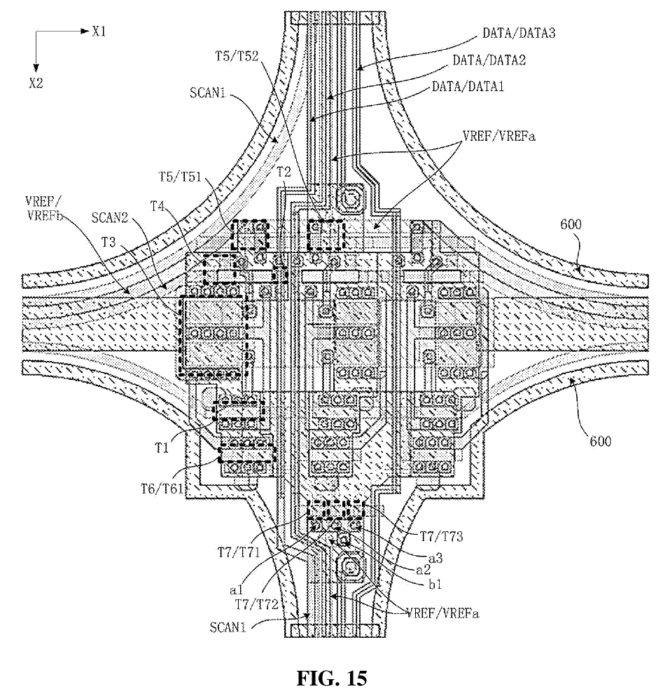

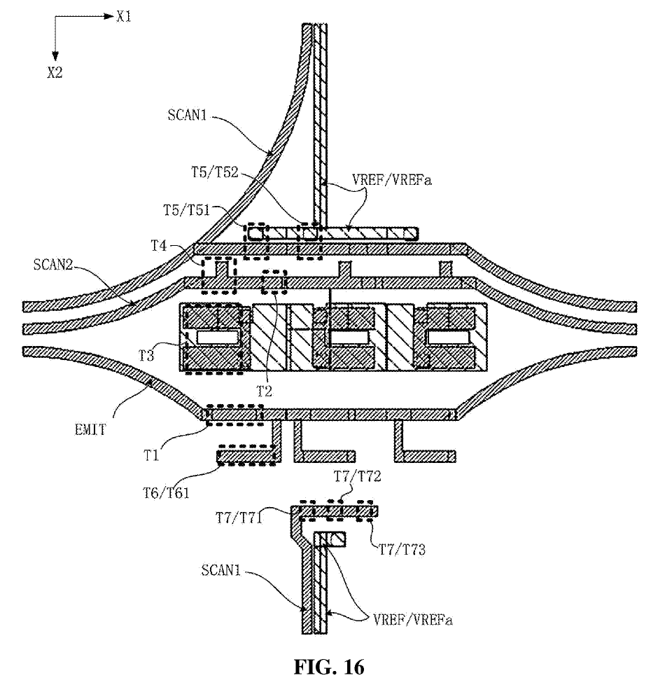

FIG. 15 is a schematic diagram showing the stacking of part structures in FIG. 6, and FIG. 16 is a schematic diagram showing the stacking of the third part structure and the fourth part structure in FIG. 6. Referring to FIG. 1, FIG. 10, FIG. 14, FIG. 15 and FIG. 16, the second pixel circuit 111b further includes a second anode reset transistor T72. The display panel 10 further includes a reset signal line VREF, the reset signal line VREF includes a first reset sub-portion VREFa, at least part of the first reset sub-portion VREFa extends in a second direction X2, and the second direction X2 intersects the first direction X1. The first anode reset transistor T71 and the second anode reset transistor T72 in the same pixel circuit group 110 are electrically connected to the same first reset sub-portion VREFa.

The display panel 10 further includes a reset signal line VREF, and the reset signal is transmitted in the reset signal line VREF, which can initialize and set some connection points in the pixel circuit 111 to ensure the working stability of the pixel circuit 111, for example, the reset signal is transmitted to the control terminal of the driving transistor T3 in the pixel circuit 111 for initialization setting, or transmitted to the first electrode 2000a of the light-emitting element 2000 for initialization setting.

In one or more embodiments, referring to FIG. 1 and FIG. 14 to FIG. 16, the first anode reset transistor T71 in the first pixel circuit 111a is electrically connected to the reset signal line VREF to transmit the reset signal to the first electrode 2000a electrically connected to the first anode reset transistor T71 in the first pixel circuit 111a. In conjunction with FIG. 14 to FIG. 16, the second pixel circuit 111b further includes a second anode reset transistor T72, and the second anode reset transistor T72 is also electrically connected to the reset signal line VREF to transmit the reset signal to the first electrode 2000a electrically connected to the second anode reset transistor T72. Further, referring to FIG. 14, the first anode reset transistor T71 in the first pixel circuit 111a is close to the second pixel circuit 111b, so the first anode reset transistor T71 and the second anode reset transistor T72 are close in distance, so that the space may be compressed, reflecting the compact design of the circuit, and the first anode reset transistor T71 and the second anode reset transistor T72, which are close in distance, may be electrically connected to the same first reset sub-portion VREFa, which facilitates space saving. It should be noted that the pixel circuit group 110 shown in FIG. 15 includes a light-shielding metal layer 12, a first semiconductor layer 13, a first metal layer 14, a second metal layer 15, and a third metal layer 16, and the film layer structure is shown in a stacked state.

In one or more embodiments, referring to FIG. 14 to FIG. 16, the first pixel circuit 111a and the second pixel circuit 111b are arranged in the first direction X1, so the first anode reset transistor T71 and the second anode reset transistor T72 are also arranged in the first direction X1, and the spacing between the first anode reset transistor T71 and the second anode reset transistor T72 is small. The reset signal line VREF includes a first reset sub-portion VREFa, and at least part of the first reset sub-portion VREFa extends in the second direction X2. In conjunction with the extension mode of the first reset sub-portion VREFa, the arrangement mode of the first pixel circuit 111a and the second pixel circuit 111b, and the small distance between the first pixel circuit 111a and the second pixel circuit 111b, the first anode reset transistor T71 and the second anode reset transistor T72 in the same pixel circuit group 110 may be electrically connected to the same first reset sub-portion VREFa. In other words, by adjusting the first anode reset transistor T71 in the first pixel circuit 111a to be close to the second reset transistor T72 in the second pixel circuit 111b, the overall occupied space of the pixel circuit group 110 can be saved, and the first anode reset transistor T71 and the second reset transistor T72 may also be connected to the same wire, thereby improving the utilization rate of the wire and reducing the occupied space of the wire.

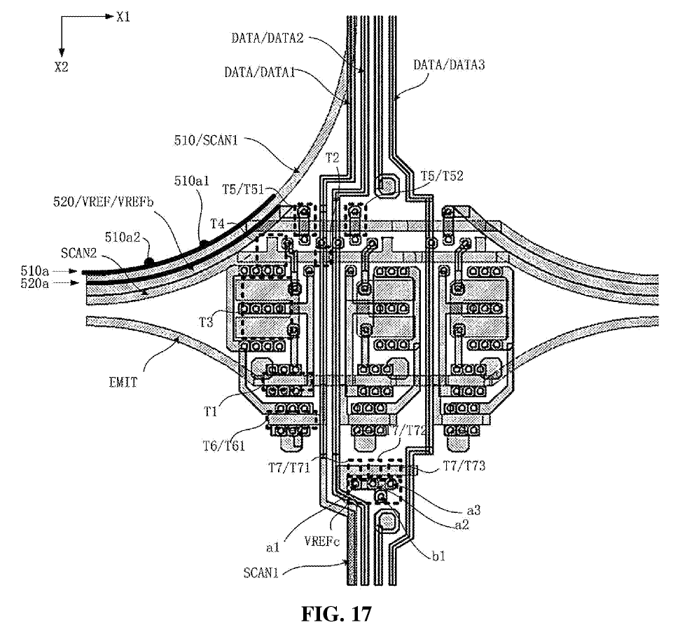

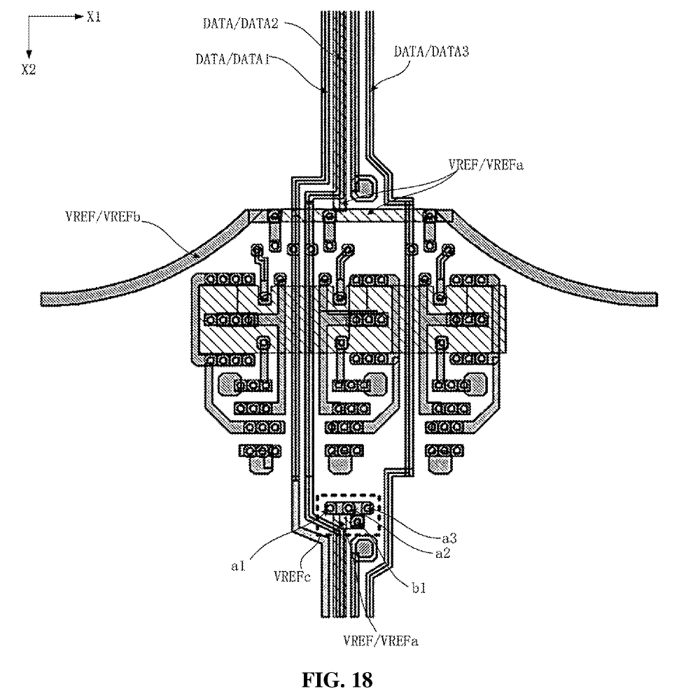

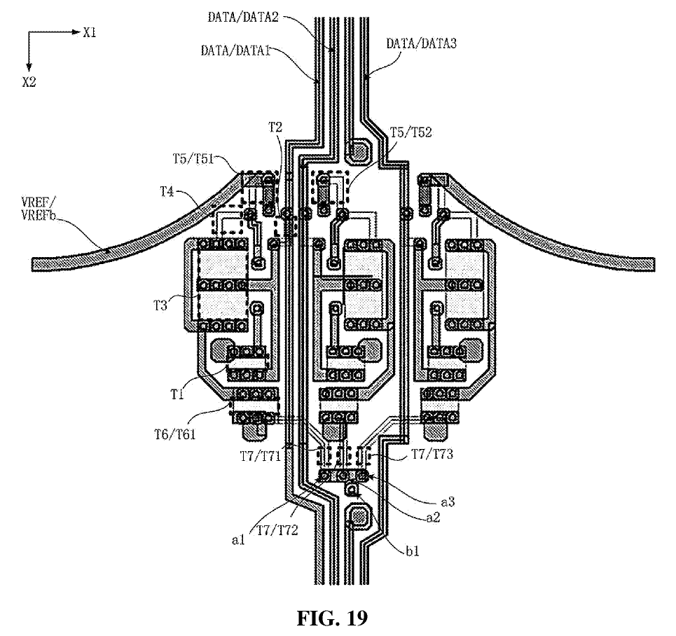

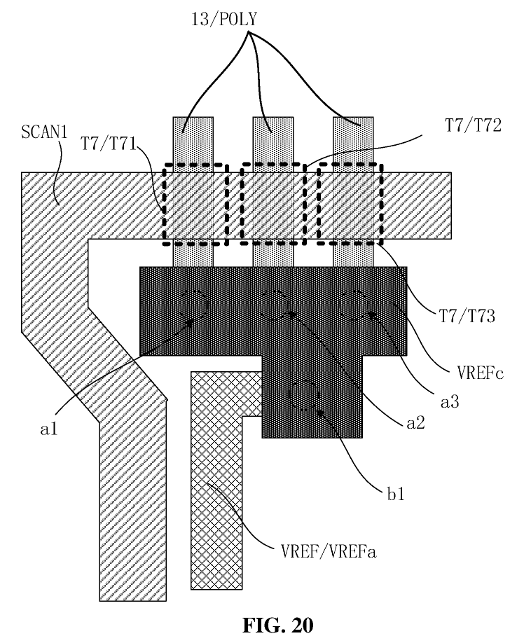

FIG. 17 is a schematic diagram showing the stacking of the third part structure and the fifth part structure in FIG. 6, FIG. 18 is a schematic diagram showing the stacking of the fourth part structure and the fifth part structure in FIG. 6, FIG. 19 is a schematic diagram showing the stacking of the second part structure and the fifth part structure in FIG. 6, and FIG. 20 is an enlarged schematic diagram of an anode reset connection portion provided in an embodiment of the present disclosure. Referring to FIG. 1, FIG. 6, FIG. 11, and FIG. 15 to FIG. 20, the display panel 10 further includes an anode reset connection portion VREFc, and the same anode reset connection portion VREFc is electrically connected to the first anode reset transistor T71 through a first connection via a1, and is electrically connected to the second anode reset transistor T72 through a second connection via a2, and is electrically connected to the first reset sub-portion VREFa through a connection via b1.

In one or more embodiments, referring to FIG. 11, the display panel 10 further includes an anode reset connection portion VREFc, and the anode reset connection portion VREFc may be understood as a connection portion, for electrically connecting structures of different film layers, for example, for electrically connecting the anode reset transistor T7 to the first reset sub-portion VREFa. Referring to FIGS. 15 to 19, in the same pixel circuit group 110, the first anode reset transistor T71 is electrically connected to the first reset sub-portion VREFa through the anode reset connection portion VREFc, and the second anode reset transistor T72 is also electrically connected to the first reset sub-portion VREFa through the anode reset connection portion VREFc. In one or more embodiments, when the pixel circuit group 110 includes a third pixel circuit 111c, the third anode reset transistor T73 in the third pixel circuit 111c is also electrically connected to the first reset sub-portion VREFa through the anode reset connection portion VREFc.

In one or more embodiments, referring to FIGS. 15 and 17 to 20, the same anode reset connection portion VREFc is electrically connected to the first anode reset transistor T71 through the first connection via a1, and is electrically connected to the second anode reset transistor T72 through the second connection via a2. In the case where the pixel circuit group 110 includes the third pixel circuit 111c, the same anode reset connection portion VREFc is electrically connected to the third anode reset transistor T73 through a third connection via a3. In this way, the first anode reset transistor T71, the second anode reset transistor T72, and the third anode reset transistor T73 are all electrically connected to the anode reset connection portion VREFc. With reference to FIG. 20, it may be understood that the active layer of the first anode reset transistor T71 located in the first semiconductor layer 13 is connected to the anode reset connection portion VREFc located in the third metal layer 16 through the first connection via a1, and the active layer of the second anode reset transistor T72 located in the first semiconductor layer 13 is connected to the anode reset connection portion VREFc located in the third metal layer 16 through the second connection via a2.

Further, reference is made to FIGS. 15, 17 to 20. Referring specifically to FIG. 20, the anode reset connection portion VREFc is electrically connected to the first reset sub-portion VREFa through the connection via b1, so that the reset signal transmitted in the first reset sub-portion VREFa may be transmitted to the first anode reset transistor T71, the second anode reset transistor T72, and the third anode reset transistor T73 through the anode reset connection portion VREFc. Referring specifically to FIG. 20, it may be understood that the anode reset connection portion VREFc located in the third metal layer 16 is connected to the first reset sub-portion VREFa located in the second metal layer 15 through the connection via b1.

Therefore, in the same pixel circuit group 110, the three anode reset transistors T7 can realize the access of the reset signal through one via (the connection via b1) at the anode reset connection portion VREFc, which can simplify the mode of electrical connection between the anode reset transistors T7 and the reset signal line VREF, reduce the process cost of the display panel 10, and also save the space occupied by the pixel circuit group 110 in the display panel 10.

Referring to FIGS. 5, 6, 11, 14 to 19, the reset signal line VREF further includes a second reset sub-portion VREFb. The second reset sub-portion VREFb is arranged in a different layer from the first reset sub-portion VREFa and is electrically connected to the first reset sub-portion VREFa. The pixel circuit 111 includes an initialization transistor T5, the first pixel circuit 111a further includes a first initialization transistor T51, and the second pixel circuit 111b further includes a second initialization transistor T52. The first initialization transistor T51 is electrically connected to the second reset sub-portion VREFb, and the second initialization transistor T52 is electrically connected to the first reset sub-portion VREFa.

In one or more embodiments, referring to FIG. 11, the reset signal line VREF further includes a second reset sub-portion VREFb, and with reference to FIGS. 5, 6, 10, and FIG. 11, the second reset sub-portion VREFb is arranged in a different layer from the first reset sub-portion VREFa and is electrically connected to the first reset sub-portion VREFa. By setting the reset signal line VREF in two layers and connecting the parts in the two layers in parallel, the resistance in the reset signal line VREF may be reduced, and the reliability and accuracy of transmission of the reset signal in the reset signal line VREF may be ensured.

Further, with reference to FIG. 2, the pixel circuit 111 includes an initialization transistor T5, and the initialization transistor T5 is also electrically connected to the reset signal line VREF. When the initialization transistor T5 is in the on state, the reset signal transmitted by the reset signal line VREF may be transmitted to the gate of the driving transistor T3 through the initialization transistor T5 to initialize the gate of the driving transistor T3.

In one or more embodiments, referring to FIG. 14 to FIG. 19, in the pixel circuit group 110, the first pixel circuit 111a further includes a first initialization transistor T51, and the second pixel circuit 111b further includes a second initialization transistor T52. Further, referring to FIGS. 15 to 18, the first initialization transistor T51 is electrically connected to the second reset sub-portion VREFb, and the second initialization transistor T52 is electrically connected to the first reset sub-portion VREFa. It may be understood that, referring to FIG. 18, although the first reset sub-portion VREFa is electrically connected to the second reset sub-portion VREFb, the first reset sub-portion VREFa is arranged in a different layer from the second reset sub-portion VREFb, so the reset signal line VREF electrically connected to the first initialization transistor T51 is arranged in a different layer from the reset signal line VREF electrically connected to the second initialization transistor T52.

In one or more embodiments, with reference to FIGS. 5, 6, 9 to 11, and FIGS. 14 to 19, the first reset sub-portion VREFa may be arranged in the second metal layer 15, the second reset sub-portion VREFb may be arranged in the third metal layer 16, and the active layer of the first initialization transistor T51 and the active layer of the second initialization transistor T52 are both arranged in the first semiconductor layer 13. The second reset sub-portion VREFb located in the third metal layer 16 is punched to the first semiconductor layer 13, and the first reset sub-portion VREFa located in the second metal layer 15 is punched to the third metal layer 16 and then punched to the first semiconductor layer 13 through the adaption of the third metal layer 16. Therefore, the depth by which the first reset sub-portion VREFa is punched to the second initialization transistor T52 and the depth by which the second reset sub-portion VREFb is punched to the first initialization transistor T51 are also inconsistent. Further, with reference to FIGS. 6, 10 and 11, the first reset sub-portion VREFa includes a wire sub-part extending in the second direction X2 and a wire sub-part extending in the first direction X1, specifically the first reset sub-portion VREFa extending in the second direction X2 is electrically connected to the anode reset transistor T7, and the first reset sub-portion VREFa extending in the first direction X1 may be connected to the second reset sub-portion VREFb through a via, so that the second reset sub-portion VREFb is arranged in a different layer from the first reset sub-portion VREFa and is electrically connected to the first reset sub-portion VREFa.

Further, according to the setting positions of the first initialization transistor T51 and the second initialization transistor T52, the modes of electrical connection between the reset signal line VREF and the first initialization transistor T51 and between the reset signal line VREF and the second initialization transistor T52 are adjusted. In this way, the modes of connection between the reset signal line VREF and the transistors in the pixel circuit 111 may be ensured to be simple, avoiding multiple punching, and reducing the process preparation cost and preparation difficulty of the display panel 10.

It should be noted that only one pixel circuit group 110 is shown in FIG. 6, and multiple pixel circuit groups 110 are arranged in the first direction X1 and the second direction X2. The first reset sub-portion VREFa near the lower end in FIG. 6 and FIG. 16 may be understood as the first reset sub-portion VREFa near the upper end in the next pixel circuit group 110 arranged in the second direction X2.

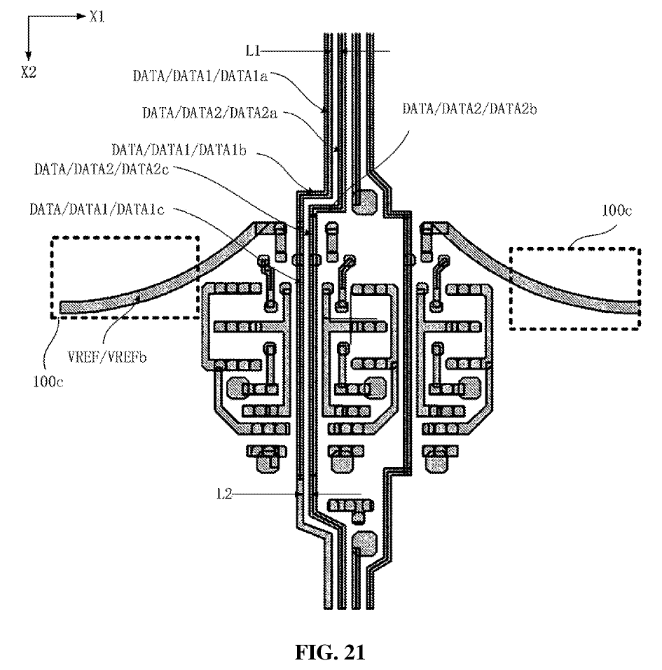

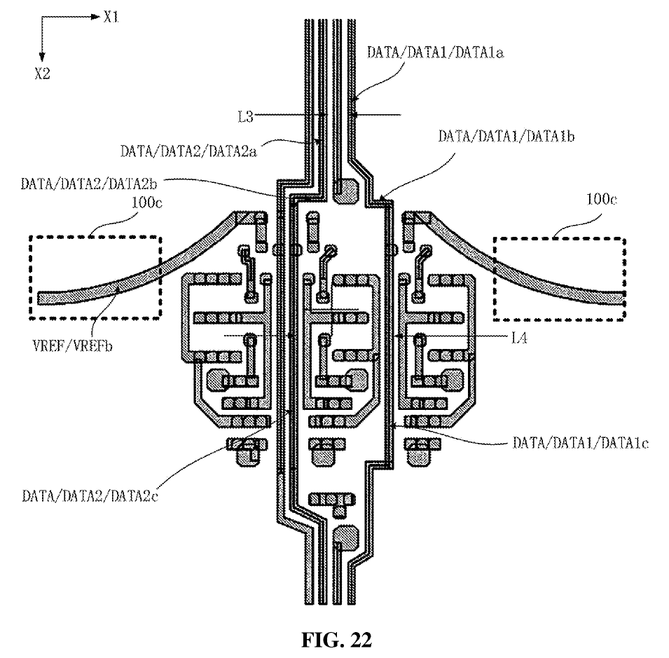

FIG. 21 is a schematic diagram of another fifth part structure in FIG. 6, and FIG. 22 is a schematic diagram of yet another fifth part structure in FIG. 6. With reference to FIG. 1, FIG. 2, and FIG. 14 to FIG. 22, the display panel 10 further includes multiple data signal line groups 200. The data signal line group 200 includes a first data signal line DATA1 and a second data signal line DATA2. The first data signal line DATA1 is electrically connected to the first pixel circuit 111a, and the second data signal line DATA2 is electrically connected to the second pixel circuit 111b. The first data signal line DATA1 includes a first data segment DATA1a, a second data segment DATA1b, and a third data segment DATA1c. The second data segment DATA1b connects the first data segment DATA1a and the third data segment DATA1c. The first data segment DATA1a and the third data segment DATA1c extend in the second direction X2, and at least part of the second data segment DATA1b extends in the first direction X1. The second data signal line DATA2 includes a fourth data segment DATA2a, a fifth data segment DATA2b, and a sixth data segment DATA2c. The fifth data segment DATA2b connects the fourth data segment DATA2a and the sixth data segment DATA2c. The fourth data segment DATA2a and the sixth data segment DATA2c extend in the second direction X2, and at least part of the fifth data segment DATA2b extends in the first direction X1. The display panel 10 further includes a wiring region 100c, the wiring region 100c is located between two light-transmitting regions 100b arranged in the second direction X2, and the second direction X2 intersects the first direction X1. The first data segment DATA1a and the fourth data segment DATA2a both overlap the light-transmitting region 100b, and the third data segment DATA1c and the sixth data segment DATA2c both overlap the wiring region 100c. In the same data signal line group 200, in the first direction X1, the distance between the first data segment DATA1a and the fourth data segment DATA2a is less than or equal to the distance between the third data segment DATA1c and the sixth data segment DATA2c.

The display panel 10 further includes multiple data signal line groups 200. The data signal line group 200 includes multiple data signal lines DATA. The data signal line group 200 may be understood as data signal lines DATA electrically connected to pixel circuits 111 in a pixel circuit group 110, and the data signal lines DATA provide data signals for the pixel circuits 111. Referring to FIG. 2, the data signal lines DATA are electrically connected to the data writing transistors T2 in the pixel circuits 111.

In one or more embodiments, referring to FIG. 6 and FIG. 11, the data signal lines DATA in the data signal line group 200 are electrically connected to the pixel circuits 111 in the pixel circuit group 110 in a one-to-one correspondence manner. In one or more embodiments, referring to FIG. 15 to FIG. 22, the data signal line group 200 includes a first data signal line DATA1 and a second data signal line DATA2, the first data signal line DATA1 is electrically connected to the first pixel circuit 111a, and the second data signal line DATA2 is electrically connected to the second pixel circuit 111b. As shown in FIG. 14 and FIG. 15, in a case where the pixel circuit group 110 includes a first pixel circuit 111a, a second pixel circuit 111b and a third pixel circuit 111c, the data signal line DATA corresponding to the pixel circuit group 110 further includes a third data signal line DATA3, and the third data signal line DATA3 is electrically connected to the third pixel circuit 111c. In one or more embodiments, as shown in FIG. 15 to FIG. 21, the first pixel circuit 111a may be located on the left side of the second pixel circuit 111b, and as shown in FIG. 20, the third pixel circuit 111c may be located on the right side of the second pixel circuit 111b, specifically the left side and the right side are described as the left and right sides in the figure.

Further, as shown in FIG. 21 and FIG. 22, the first data signal line DATA1 includes the first data segment DATA1a, the second data segment DATA1b, and the third data segment DATA1c. The second data segment DATA1b connects the first data segment DATA1a and the third data segment DATA1c, that is, the second data segment DATA1b is equivalent to the connection portion between the first data segment DATA1a and the third data segment DATA1c. The first data segment DATA1a and the third data segment DATA1c extend in the second direction X2, and at least part of the second data segment DATA1b extends in the first direction X1. That is to say, the first data segment DATA1a, and the third data segment DATA1c extend in a straight line, but there is a wire in the second data segment DATA1b that extends in a different direction from the first data segment DATA1a. The second data segment DATA1b may be understood as a "bending wire" connecting the first data segment DATA1a and the third data segment DATA1c.

Similarly, referring to FIGS. 21 and 22, the second data signal line DATA2 includes the fourth data segment DATA2a, the fifth data segment DATA2b and the sixth data segment DATA2c. The fifth data segment DATA2b connects the fourth data segment DATA2a and the sixth data segment DATA2c, that is, the fifth data segment DATA2b is equivalent to the connection portion between the fourth data segment DATA2a and the sixth data segment DATA2c. The fourth data segment DATA2a and the sixth data segment DATA2c extend in the second direction X2, and at least part of the fifth data segment DATA2b extends in the first direction X1. That is to say, the fourth data segment DATA2a and the sixth data segment DATA2c extend in a straight line, but there is a wire in the fifth data segment DATA2b that extends in a different direction from the fourth data segment DATA2a. The fifth data segment DATA2b may be understood as a "bending wire" connecting the fourth data segment DATA2a and the sixth data segment DATA2c.

The display panel 10 includes a wiring region 100c, the wiring region 100c is located between two light-transmitting regions 100b arranged in the second direction X2, and multiple wires are arranged in the wiring region 100c to realize the electrical connection between the wires and the pixel circuits 111.

In one or more embodiments, with reference to FIG. 1, FIG. 6, FIG. 21, and FIG. 22, the first data segment DATA1a and the fourth data segment DATA2a each overlap the light-transmitting regions 100b, that is, the light-transmitting regions 100b are on two sides of the first data segment DATA1a and the fourth data segment DATA2a in the first direction X1. The third data segment DATA1c and the sixth data segment DATA2c each overlap the wiring region 100c; that is, the third data segment DATA1c and the sixth data segment DATA2c are the wiring parts of the data signal lines DATA extending into the circuit setting region 100a.

Further, referring to FIG. 21, in the same data signal line group 200, in the first direction X1, the distance between the first data segment DATA1a and the fourth data segment DATA2a may be equal to the distance between the third data segment DATA1c and the sixth data segment DATA2c, referring to FIG. 21, L1=L2, so that the balance of the overall wiring of the display panel 10 may be ensured, and the difficulty of manufacturing the display panel 10 may be reduced.

Further, referring to FIG. 22, in the same data signal line group 200, in the first direction X1, the distance between the first data segment DATA1a and the fourth data segment DATA2a may be smaller than the distance between the third data segment DATA1c and the sixth data segment DATA2c. Referring to FIG. 22, L3<L4, so that the space occupied by the data signal line DATA in the wiring region 100c may be reduced, and more space may be provided for the light-transmitting region 100b, thereby ensuring the light-transmitting display effect of the display panel 10.

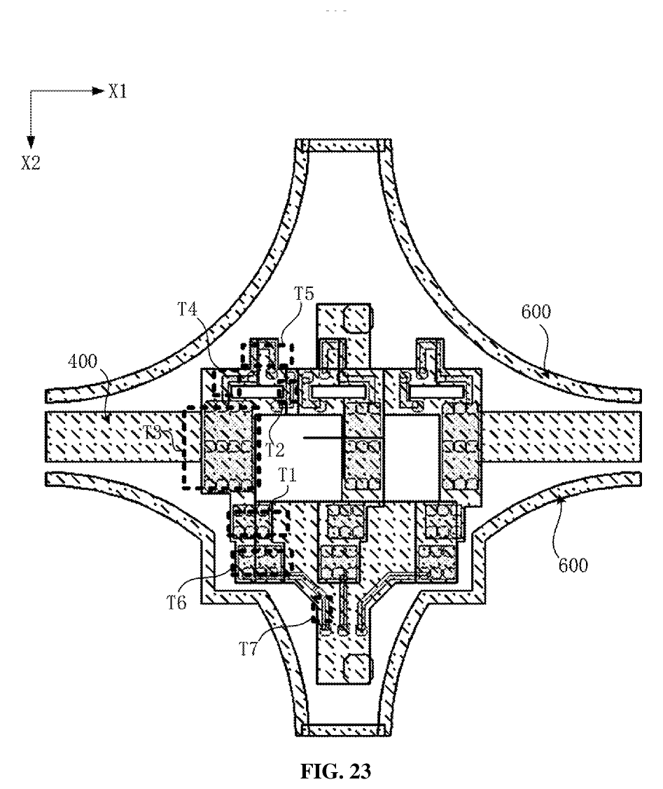

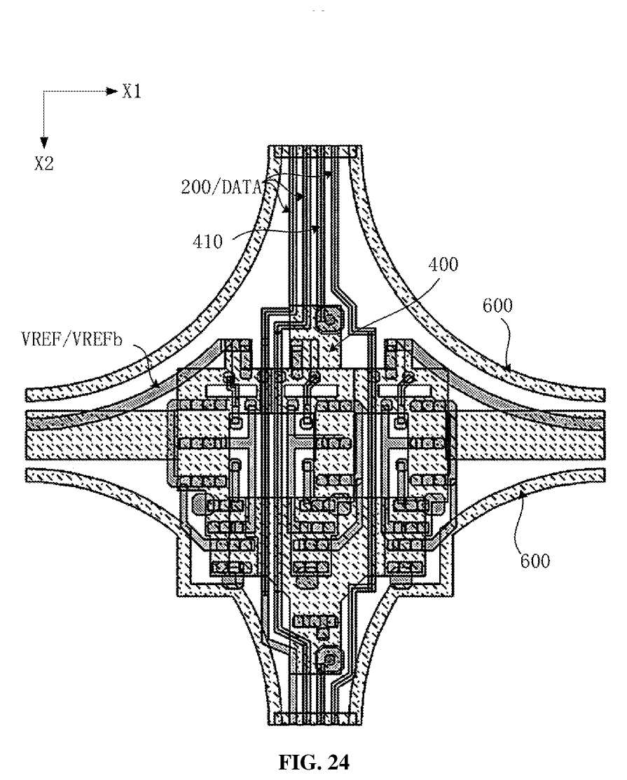

FIG. 23 is a schematic diagram showing the stacking of the first part structure and the second part structure in FIG. 6, and FIG. 24 is a schematic diagram showing the stacking of the first part structure, the second part structure, and the fifth part structure in FIG. 6. Referring to FIG. 4, FIG. 5, FIG. 6, FIG. 7, FIG. 8, FIG. 9, FIG. 14, FIG. 23, and FIG. 24, the light-emitting control transistor T6 and/or the anode reset transistor T7 include an active layer, and the active layer includes a channel region. The display panel 10 further includes a substrate 11 and a light-shielding structure 400. The light-shielding structure 400 is located in the circuit setting region 100a and on a side of the active layer close to the substrate 11. In the direction perpendicular to the plane where the substrate 11 is located, the light-shielding structure 400 overlaps at least part of the channel region.

In one or more embodiments, referring to FIG. 4, FIG. 5, FIG. 6, FIG. 8, FIG. 9 and FIG. 14, the light-emitting control transistor T6 and/or the anode reset transistor T7 include an active layer, and the transistor region correspondingly shown in FIG. 8 may be understood as the corresponding active layer, and the active layer is arranged in the first semiconductor layer 13. The active layer further includes a channel region. As shown in FIG. 8, FIG. 9, and FIG. 14, the channel region in the active layer may be understood as: in the thickness direction of the display panel 10, the region where the wire (the wire transmits signals for controlling the transistors to be on or off) located in the first metal layer 14 overlaps the corresponding active layer.

In one or more embodiments, referring to FIG. 8, the active layer of the light-emitting control transistor T6 is as a T6 region marked in FIG. 14. As shown in FIG. 14, the region where the light-emitting control signal line EMIT overlaps the active layer of the light-emitting control transistor T6 is the channel region of the light-emitting control transistor T6. Similarly, the active layer of the anode reset transistor T7 is as a T7 region marked in FIG. 14. As shown in FIG. 14, the region where the reset signal line VREF overlaps the active layer of the anode reset transistor T7 is the channel region of the anode reset transistor T7.

Further, referring to FIG. 5 to FIG. 7, the display panel 10 further includes a light-shielding structure 400. The light-shielding structure 400 is located on one side of the substrate 11, and may be arranged in the film layer where the light-shielding metal layer 12 is located. The light-shielding structure 400 has the effect of blocking light and can prevent light from passing through. In one or more embodiments, referring to FIGS. 23 and 24, in the thickness direction of the display panel 10, the light-shielding structure 400 overlaps at least part of the channel region, and the light-shielding structure 400 is equivalent to protecting the channel region of the active layer, avoiding the situation where light is irradiated to the channel region to cause light leakage, and ensuring the working stability of the corresponding transistor.

Further, referring to FIGS. 5, 6, 7, 11, 21, 23 and 24, the display panel 10 further includes a light-shielding connection structure 410, the light-shielding connection structure 410 is configured to connect two light-shielding structures 400 adjacently arranged in the second direction X2, and the light-shielding connection structure 410 is electrically connected to a fixed potential signal line. In the first direction X1, the light-shielding connection structure 410 is located between the first data segment DATA1a and the fourth data segment DATA2a.

Further, with reference to FIGS. 5, 6, 7, and FIG. 11, or with reference to FIGS. 21, 23, and FIG. 24, the display panel 10 further includes a light-shielding connection structure 410, which can connect two light-shielding structures 400 adjacently arranged in the second direction X2. When a light-shielding connection structure 410 is electrically connected to the fixed potential signal, the fixed potential signal is also transmitted in the light-shielding structures 400 connected to the light-shielding connection structure 410. In this way, the light-shielding structures 400 can not only prevent light from being transmitted to the corresponding channel regions, but also shield the electrical signals, prevent other signals from interfering with the transistors, ensure the working stability of the pixel circuits 111, and ensure the overall display effect of the display panel 10. In one or more embodiments, the fixed potential signal line may be a power signal line, etc. The specific type of the fixed potential signal line may be adaptively adjusted according to the requirements, and the embodiment of the present disclosure does not specifically limit this.

In one or more embodiments, the light-shielding structure 400 may be arranged in the film layer where the light-shielding metal layer 12 is located, and the light-shielding connection structure 410 may be arranged in the same layer as the data signal line DATA (arranged in the film layer where the third metal layer 16 is located), that is, the light-shielding structure 400 may be located in a different film layer from the film layer where the light-shielding connection structure 410 is located.

Further, referring to FIGS. 5, 6, 11, 21, and FIG. 24, in the first direction X1, the light-shielding connection structure 410 is located between the first data segment DATA1a and the fourth data segment DATA2a, which can ensure the balance of the wiring in the display panel 10. The third metal layer 16, where the data signal lines DATA are located, generally has a small resistivity, and also setting the light-shielding connection structure 410, electrically connected to the fixed potential signal line, in the film layer can ensure the effect of signal transmission. Further, the light-shielding connection structure 410 is set between the first data segment DATA1a and the fourth data segment DATA2a. In the preparation process of the display panel 10, the light-shielding connection structure 410 may be prepared synchronously with the data signal line DATA, thereby reducing the process cost of the display panel 10.

Continuing to refer to FIG. 1, FIG. 6, FIG. 9, FIG. 11, and FIG. 12, the display panel 10 further includes a signal line 500, and the signal line 500 is electrically connected to the pixel circuit 111. An edge of the signal line 500 on a side close to the light-transmitting region 100b includes a non-straight line.

In one or more embodiments, referring to FIG. 1 and FIG. 6, the display panel 10 further includes a signal line 500, and the signal line 500 is electrically connected to the pixel circuit 111, and is configured to provide the pixel circuit 111 with related signals. Further, the wire of the signal line 500 on the side close to the light-transmitting region 100b may be understood as forming the contour line of the light-transmitting region 100b. By adjusting the shape of the signal line 500 near the light-transmitting region 100b, the light-transmitting region 100b may be adjusted to have a non-linear contour shape. Compared with the light-transmitting region 100b having a linear contour shape, the light-transmitting region 100b having a non-linear contour shape can effectively mitigate the light diffraction in the light-transmitting region 100b, reduce the overall diffraction phenomenon of the display panel 10, and enhance the light transmission effect of the display panel 10.

Continuing to refer to FIGS. 1, 6, 9, 11, and FIG. 12, the edge of the signal line 500 near the light-transmitting region 100b includes a curve. The curve has a fixed radius of curvature.

Further, the non-linear edge of the signal line 500 near the light-transmitting region 100b may be a curve, and the curve has a fixed radius of curvature. In this way, it may ensure that the contour of the light-transmitting region 100b defined by the signal line 500 may be smoother, thereby better reducing diffraction and ensuring the light transmittance of the light-transmitting region 100b.

In one or more embodiments, referring to FIG. 1 and FIG. 6, by adjusting the non-straight portion of the signal line 500 to a curve, a smoother and neater light-transmitting region 100b may be formed. Referring to FIG. 1, when the adjusted curvature radii of the signal lines 500 electrically connected to two adjacent pixel circuit groups 110 are the same or similar, a nearly circular or circular light-transmitting region 100b as shown in FIG. 1 may be formed.

Continuing to refer to FIG. 1, FIG. 6, FIG. 9, FIG. 11 and FIG. 12, the display panel 10 further includes a first scanning signal line SCAN1, a second scanning signal line SCAN2 and a light-emitting control signal line EMIT. The pixel circuit 111 further includes an initialization transistor T5 and a data writing transistor T2. The control terminal of the initialization transistor T5 and the control terminal of the anode reset transistor T7 are both electrically connected to the first scanning signal line SCAN1, the control terminal of the data writing transistor T2 is electrically connected to the second scanning signal line SCAN2, and the control terminal of the light-emitting control transistor T6 is electrically connected to the light-emitting control signal line EMIT. The signal line 500 includes at least one of the first scanning signal line SCAN1, the second scanning signal line SCAN2 and the light-emitting control signal line EMIT.

The display panel 10 includes multiple wires electrically connected to the control terminals of the transistors, such as the first scanning signal line SCAN1, the second scanning signal line SCAN2, and the light-emitting control signal line EMIT. For at least one of the first scanning signal line SCAN1, the second scanning signal line SCAN2, and the light-emitting control signal line EMIT, it may be the signal line 500 described above.

In one or more embodiments, referring to FIG. 6 and FIG. 9, the first scanning signal line SCAN1 electrically connected to the control terminal of the initialization transistor T5 and the control terminal of the anode reset transistor T7 respectively may be a signal line 500, specifically the first scanning signal line SCAN1 includes a non-straight wire (referring to the wire portion indicated by d1 in FIG. 9). The second scanning signal line SCAN2 electrically connected to the control terminal of the data writing transistor T2 may be a signal line 500, specifically, the second scanning signal line SCAN2 includes a non-straight wire (referring to the wire portion indicated by d2 in FIG. 9). The light-emitting control signal line EMIT electrically connected to the control terminal of the light-emitting control transistor T6 may be a signal line 500, specifically, the light-emitting control signal line EMIT includes a non-straight wire (referring to the wire portion indicated by d3 in FIG. 9).

Further, referring to FIG. 6 and FIG. 11, the second reset sub-portion VREFb electrically connected to the initialization transistor T5 may be a signal line 500, specifically, the second reset sub-portion VREFb includes a non-straight wire (referring to the wire portion indicated by d4 in FIG. 11). Referring to FIG. 6 and FIG. 12, the first power signal line PVDD electrically connected to the data writing transistor T2 may be a signal line 500, specifically, the first power signal line PVDD includes a non-straight wire (referring to the wire portion indicated by d5 in FIG. 12).

In one or more embodiments, the display panel 10 further includes the second power signal line PVEE electrically connected to the second electrode 2000b in the light-emitting element 2000, and the second power signal line PVEE may also include a non-straight wire near the light-transmitting region 100b (referring to the wire portion indicated by d6 in FIG. 13).

FIG. 25 is a schematic diagram of a film layer structure of another display panel provided in an embodiment of the present disclosure. Referring to FIG. 1, FIG. 2, FIG. 4, FIG. 6, and FIG. 25, the circuit setting regions 100a are arranged in a first direction X1 into a circuit setting region row 1000, circuit setting region rows 1000 are arranged in a second direction X2, and the second direction X2 intersects the first direction X1. Multiple circuit setting region rows 1000 include a first circuit setting region row 1001 and a second circuit setting region row 1002 adjacently arranged in the second direction X2. The first scanning signal line SCAN1 includes a first scanning sub-portion SCAN1a, a second scanning sub-portion SCAN1b, and a scanning connection portion SCAN1c. The first scanning sub-portion SCAN1a is electrically connected to the control terminals of multiple anode reset transistors T7 in the first circuit setting region row 1001, the second scanning sub-portion SCAN1b is electrically connected to the control terminals of multiple initialization transistors T5 in the second circuit setting region row 1002, and the scanning connection portion SCAN1c connects the first scanning sub-portion SCAN1a and the second scanning sub-portion SCAN1b. The signal line 500 includes part of the second scanning sub-portion SCAN1b and the scanning connection portion SCAN1c, and the curvature radii of the second scanning sub-portion SCAN1b and the scanning connection portion SCAN1c are the same.

In one or more embodiments, referring to FIGS. 1 and 25, the circuit setting regions 100a are arranged in the first direction X1 into a circuit setting region row 1000, and circuit setting region rows 1000 are arranged in the second direction X2. The figures show the circuit setting row 1000 including two pixel circuit groups 110 for illustration. There are no specific limitations on the number of pixel circuit groups 110 in the circuit setting region row 1000 and the number of circuit setting region rows 1000 in the display panel 10, and they may be adaptively adjusted according to practical requirements. It should be noted that FIG. 6 may be understood as an enlarged schematic diagram of a pixel circuit group 110 in FIG. 25. To clearly show the wires, not all film layers are shown one by one in FIG. 25. For the specific details of the pixel circuit group 110, reference may be made to FIG. 6.

Further, referring to FIG. 25, the circuit setting region row 1000 includes a first circuit setting region row 1001 and a second circuit setting region row 1002, adjacently arranged in the second direction X2. As shown in FIG. 25, in the first circuit setting region row 1001, some wires extend across adjacent pixel circuit groups 110 in the first circuit setting region row 1001, and in the second circuit setting region row 1002, some wires extend across the adjacent pixel circuit groups 110 in the second circuit setting region row 1002. Moreover, some wires extend across the adjacent first circuit setting region row 1001 and second circuit setting region row 1002. Thus, the whole-surface transmission of the signal in the display panel 10 is realized, and the whole-surface display effect of the display panel 10 is ensured.

Further, referring to FIG. 25, the first scanning signal line SCAN1 includes a first scanning sub-portion SCAN1a, a second scanning sub-portion SCAN1b, and a scanning connection portion SCAN1c. In one or more embodiments, the two sides of the scanning connection portion SCAN1c are electrically connected to the first scanning sub-portion SCAN1a and the second scanning sub-portion SCAN1b respectively, and by setting the first scanning signal line SCAN1 in portions, the scan signal may be transmitted to different pixel circuits 110.

With reference to FIG. 6 and FIG. 25, the first scanning sub-portion SCAN1a is electrically connected to the control terminal of multiple anode reset transistors T7 in the first circuit setting region row 1001. The second scanning sub-portion SCAN1b is electrically connected to the control terminal of multiple initialization transistors T5 in the second circuit setting region row 1002. The scanning connection portion SCAN1c connects adjacent first scanning sub-portion SCAN1a and second scanning sub-portion SCAN1b. In one or more embodiments, the anode reset transistor T7 in the first circuit setting region row 1001 and the initialization transistor T5 in the second circuit setting region row 1002 are transistors in pixel circuits 111 of different rows (arranged in the second direction X2), but the two transistors may be connected to the same first scanning signal line SCAN1. Therefore, it may be seen that in the same pixel circuit 111, the first scanning signal line SCAN1 connected to the initialization transistor T5 may be understood as the first scanning signal line SCAN1 of the previous row, and the first scanning signal line SCAN1 connected to the anode reset transistor T7 may be understood as the first scanning signal line SCAN1 of a next row of the previous row.

Further, referring to FIG. 25, the first scanning sub-portion SCAN1a, the scanning connection portion SCAN1c and the second scanning sub-portion SCAN1b are connected, and the curvature radii of the second scanning sub-portion SCAN1b and the scanning connection portion SCAN1c are the same, so that the second scanning sub-portion SCAN1b and the scanning connection portion SCAN1c form a smooth arc surface. The corresponding second scanning sub-portion SCAN1b and the scanning connection portion SCAN1c are close to the light-transmitting region 100b, this ensures that the contour line of the light-transmitting region 100b formed is a smooth arc surface, thereby reducing the diffraction of the display panel 10 in the light-transmitting region 100b, and improving the light-transmitting effect of the display panel 10 in the light-transmitting region 100b.

With reference to FIG. 1, FIG. 2, FIG. 6, FIG. 11, and FIG. 14 to FIG. 19, the display panel 10 further includes a reset signal line VREF, and the reset signal line VREF includes a second reset sub-portion VREFb. The first pixel circuit 111a further includes a first initialization transistor T51, and the first initialization transistor T51 is electrically connected to the second reset sub-portion VREFb. The signal line 500 includes the second reset sub-portion VREFb.

Referring to FIG. 6, FIG. 11, and FIG. 14, the reset signal line VREF electrically connected to the pixel circuit 111 includes the second reset sub-portion VREFb, and the first initialization transistor T51 in the first pixel circuit 111a is electrically connected to the second reset sub-portion VREFb. A part of the wire of the second reset sub-portion VREFb close to the light-transmitting region 100b may be set as a non-straight line, so that the contour line of the light-transmitting region 100b may be effectively ensured to be a smooth arc surface, thereby reducing the diffraction of the display panel 10 in the light-transmitting region 100b, and improving the light-transmitting effect of the display panel 10 in the light-transmitting region 100b.

In one or more embodiments, the first pixel circuit 111a is closer to the light-transmitting region 100b than the second pixel circuit 111b is, so a part of the wire of the second reset sub-portion VREFb electrically connected to the first pixel circuit 111a is close to the light-transmitting region 100b, therefore the part of the wire may be bent to improve the light-transmitting effect of the display panel 10 in the light-transmitting region 100b.

With reference to FIGS. 1, 2, 6 and 12, the pixel circuit 111 further includes a power signal writing transistor T1. The display panel 10 further includes a first power signal line PVDD, and the first power signal line PVDD is electrically connected to the first terminal of the power signal writing transistor T1. The signal line 500 includes the first power signal line PVDD.

Referring to FIGS. 6 and 12, the display panel 10 further includes a first power signal line PVDD, and the first power signal line PVDD is electrically connected to the power signal writing transistor T1 in the pixel circuit 111, and when the power signal writing transistor T1 is turned on, the power signal transmitted by the first power signal line PVDD is transmitted to the pixel circuit 111.

Furthermore, the signal line 500 may further include the first power signal line PVDD, and the edge of the first power signal line PVDD near the light-transmitting region 100b may be a non-straight line. By bending the edge of the first power signal line PVDD near the light-transmitting region 100b, the light-transmitting effect of the display panel 10 in the light-transmitting region 100b may be improved.

In one or more embodiments, referring to FIG. 2, FIG. 6, FIG. 12 and FIG. 13, the display panel 10 further includes a second power signal line PVEE, specifically the power signal transmitted in the first power signal line PVDD is V1, and the power signal transmitted in the second power signal line PVEE is V2, satisfying: |V1-V2|>0. The first power signal line PVDD is electrically connected to the power signal writing transistor T1 in the pixel circuit 111, and the power signal V1 is transmitted to the driving transistor T3 in the pixel circuit 111 to generate a driving current, and then the driving current is transmitted to the first electrode 2000a of the light-emitting element 2000. The second power signal PVEE is electrically connected to the second electrode 2000b of the light-emitting element 2000 to realize the driving and light emission of the light-emitting element 2000.

Further, the edge of the second power signal line PVEE close to the light-transmitting region 100b may also be set in a curve to avoid the diffraction of light in the light-transmitting region 100b, which is conducive to improving the light-transmitting effect of the display panel 10 in the light-transmitting region 100b.

Continuing to refer to FIG. 6, FIG. 15 and FIG. 17, at least two signal lines 500 surrounding the same light-transmitting region 100b include a first signal line 510 and a second signal line 520. The first signal line 510 includes a first signal line edge 510a on the side close to the light-transmitting region 100b, and the second signal line 520 includes a second signal line edge 520a on the side close to the light-transmitting region 100b. The first signal line edge 510a and the second signal line edge 520a overlap in both the first direction X1 and the second direction X2. The second direction X2 intersects the first direction X1. Any two points on the first signal line edge 510a include a first point 510a1 and a second point 510a2, and the minimum distance between the first point 510a1 and the second signal line edge 520 is equal to the minimum distance between the second point 510a2 and the second signal line edge 520.

The display panel 10 includes multiple signal lines 500. As shown in FIG. 17, the signal line 500 includes a first signal line 510 and a second signal line 520. The first signal line 510 and the second signal line 520 both have non-straight wire portions close to the light-transmitting region 100b. In one or more embodiments, the first signal line 510 includes a first signal line edge 510a on the side close to the light-transmitting region 100b, and the second signal line 520 includes a second signal line edge 520a on the side close to the light-transmitting region 100b. For the first signal line edge 510a and the second signal line edge 520a, reference may be made to the bolded regions in FIG. 17. In one or more embodiments, the first signal line 510 may be the first scanning signal line SCAN1, and the second signal line 520 may be the second reset sub-portion VREFb.

Furthermore, the first signal line edge 510a and the second signal line edge 520a overlap in the first direction X1 and the second direction X2, that is, part of the wire of the first signal line 510 overlaps part of the wire of the second signal line 520 in the first direction X1 and the second direction X2, and the side of the first signal line 510 at the overlapping part close to the light-transmitting region 100b is the first signal line edge 510a, and the side of the second signal line 520 close to the light-transmitting region 100b is the second signal line edge 520a. It should be noted that the understanding of overlap may be in multiple situations. The first situation: when the first signal line 510 is arranged in a different layer from the second signal line 520, the projection of the first signal line 510 on the substrate 100 and the projection of the second signal line 520 on the substrate 100 overlap, and when the second signal line 520 is located at the side of the first signal line 510 away from the light-transmitting region 100b, the projection of the second signal line edge 520a on the substrate 100 may overlap the first signal line 510. The second situation: regardless of whether the first signal line 510 is arranged in the same or different layer from the second signal line 520, the projection of the first signal line 510 on the substrate 100 and the projection of the second signal line 520 on the substrate 100 do not overlap, and when the second signal line 520 is located at the side of the first signal line 510 away from the light-transmitting region 100b, the projection of the second signal line edge 520a on the substrate 100 does not overlap the first signal line 510, and a certain distance exists therebetween.

Continuing to refer to FIG. 17, when any two points are selected from the first signal line edge 510a, and the minimum distances between the second signal line 520 and the any two points are the same, this can reflect that the bending degree of the first signal line 510 at the first signal line edge 510a is consistent with the bending degree of the second signal line 520 at the second signal line edge 520a. In one or more embodiments, the any two points selected from the first signal line edge 510a are the first point 510a1 and the second point 510a2, specifically, the minimum distance between the first point and the second signal line edge 520 is equal to the minimum distance between the second point 510a2 and the second signal line edge 520. In this way, the wires near the light-transmitting region 100b in the display panel 10 may be ensured to be consistent, and the wiring is more regular. Moreover, the bending degrees of the signal lines 500 that overlap in the first direction X1 and the second direction X2 are set to be the same or similar, to better weaken the diffraction effect of the light-transmitting region 100b and improve the light-transmitting effect of the display panel 10 in the light-transmitting region 100b.

Continuing to refer to FIG. 6, at least two signal lines 500 surrounding the same light-transmitting region 100b include a third signal line 530 and a fourth signal line 540. The third signal line 530 includes a third signal line edge 530a on the side close to the light-transmitting region 100b, and the fourth signal line includes a fourth signal line edge 540a on the side close to the light-transmitting region 100b. In the thickness direction of the display panel 10, at least part of the third signal line edge 530a overlaps at least part of the fourth signal line edge 540a.

In one or more embodiments, the display panel 10 includes multiple signal lines 500, and referring to FIG. 6, the signal lines 500 include a third signal line 530 and a fourth signal line 540, and both the third signal line 530 and the fourth signal line 540 have non-straight wire portions close to the light-transmitting region 100b. In one or more embodiments, the third signal line 530 includes a third signal line edge 530a on the side close to the light-transmitting region 100b, and the fourth signal line 540 includes a fourth signal line edge 540a on the side close to the light-transmitting region 100b.

Continuing to refer to FIG. 6, in the thickness direction of the display panel 10, at least part of the third signal line edge 530a overlaps at least part of the fourth signal line edge 540a. In one or more embodiments, the third signal line 530 is the first scanning signal line SCAN1, and the fourth signal line 540 is the first power signal line PVDD. That is, in the thickness direction of the display panel 10, the edge of the non-straight portion of the wire of the first scanning signal line SCAN1, close to the light-transmitting region 100b, overlaps the edge of the non-straight portion of the wire of the first power signal line PVDD, close to the light-transmitting region 100b. By overlapping the wires, close to the light-transmitting region 100b, in the thickness direction of the display panel 10, the blocking of the wires on the light-transmitting region 100b may be reduced, thereby increasing the light-transmitting area of the light-transmitting region 100b, and improving the overall light-transmitting effect of the display panel 10.

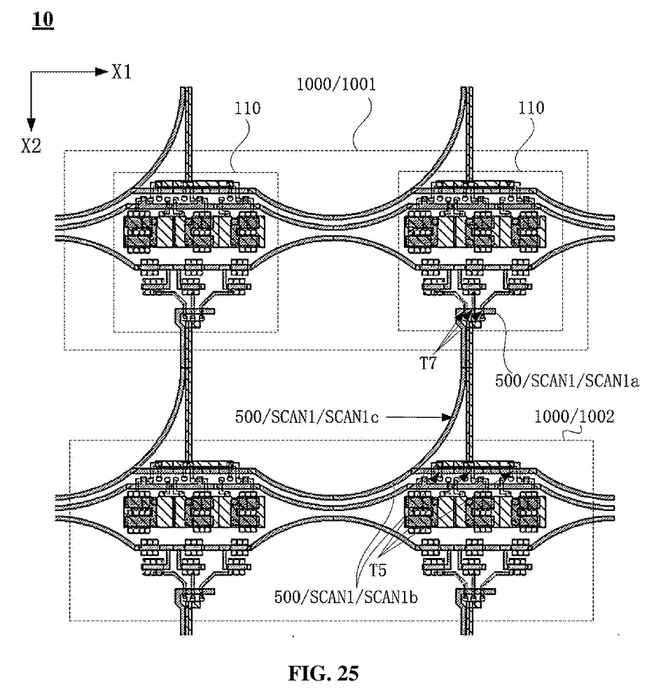

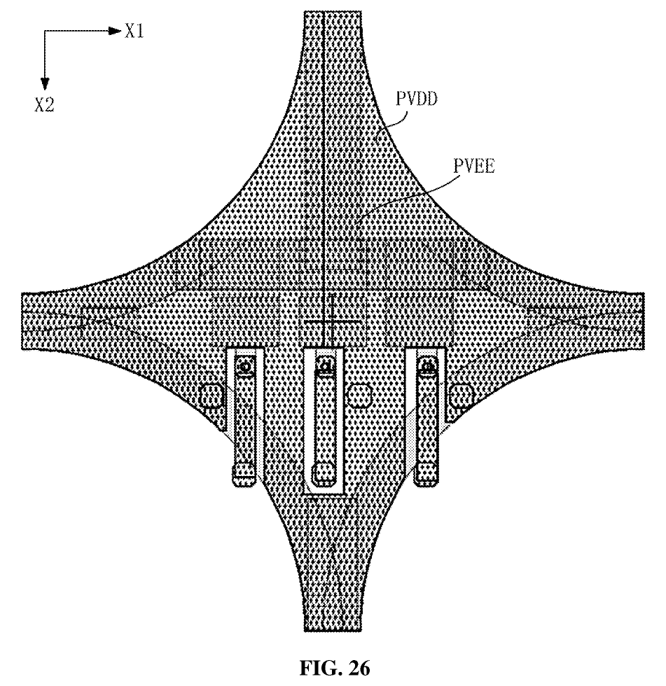

Further, FIG. 26 is a schematic diagram showing the stacking of the sixth part structure and the seventh part structure in FIG. 6. Referring to FIG. 26, in the thickness direction of the display panel 10, part of the edge wire of the first power signal line PVDD close to the light-transmitting region 100b may also overlap part of the edge wire of the second power signal line PVEE close to the light-transmitting region 100b, so that the blocking of the wires on the light-transmitting region 100b may be reduced, thereby increasing the light-transmitting area of the light-transmitting region 100b, and improving the overall light-transmitting effect of the display panel 10.

Continuing to refer to FIG. 1, FIG. 6, and FIG. 7, the display panel 10 further includes multiple temperature sensing units 600, and the temperature sensing unit 600 is arranged in the circuit setting region 100a and partially surrounds the light-transmitting region 100b. An edge of the temperature sensing unit 600 on the side close to the light-transmitting region 100b includes a non-straight line.

In the process of display, the display panel 10 will generate heat, and the different heat values generated will affect the display effect of the display panel 10 to varying degrees. Therefore, the display panel 10 further includes multiple temperature sensing units 600, and the temperature sensing unit 600 can adjust the signal output by itself according to the temperature value, and then the control unit 900 in the display panel 10 can adaptively adjust the display panel 10 according to the signal output by the temperature sensing unit 600, to ensure the overall display effect of the display panel 10.

In one or more embodiments, the temperature sensing unit 600 is a wire arranged in the circuit setting region 100a, and the control unit can calculate the current temperature value according to the change of the electrical signal transmitted in the temperature sensing unit 600. For example, the temperature sensing unit 600 has different resistance values at different temperatures. In this way, when the input signal remains unchanged, the signal transmitted and output by the temperature sensing unit 600 will vary depending on the temperature, and the temperature in the display panel 10 is determined according to the signal output by the temperature sensing unit 600. Further, the display panel 10 can perform gamma adjustment on the display of the light-emitting element 1000 according to the corresponding sensed temperature value, so as to ensure the overall display effect of the display panel 10.

Further, referring to FIGS. 6 and 7, the temperature sensing unit 600 is arranged at the circuit setting region 100a, and part of the wire in the temperature sensing unit 600 is arranged around the light-transmitting region 100b. To reduce the diffraction phenomenon at the light-transmitting region 100b, a wire edge of the temperature sensing unit 600 close to the light-transmitting region 100b is set as a non-straight line, referring to the edge indicated by h1 in FIG. 7.

Further, referring to FIGS. 1, 6, and 7, the temperature sensing unit 600 is located on the side of the signal line 500 near the light-transmitting region 100b.

As shown in FIG. 6 and FIG. 7, to prevent the temperature sensing unit 600 from interfering with the electrical signal transmitted in the pixel circuit 111, the temperature sensing unit 600 is arranged closer to the light-transmitting region 100b, that is, the temperature sensing unit 600 is located on the side of the signal line 500 close to the light-transmitting region 100b. In other words, referring to FIG. 6, the temperature sensing unit 600 is closer to the light-transmitting region 100b than other wires electrically connected to the pixel circuit 111 are. In this way, the display panel 10 can adaptively adjust the display panel 10 according to the temperature value sensed by the temperature sensing unit 600, and will not interfere with the signal transmission in the pixel circuit 111, thereby better ensuring the overall display effect of the display panel 10.

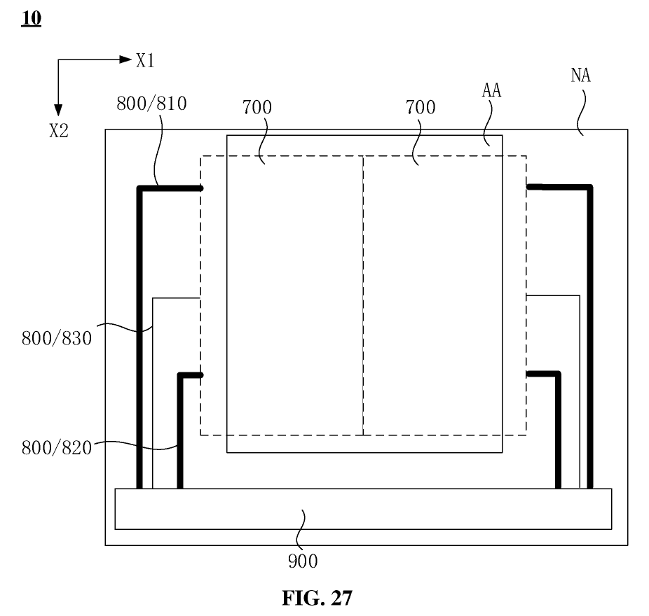

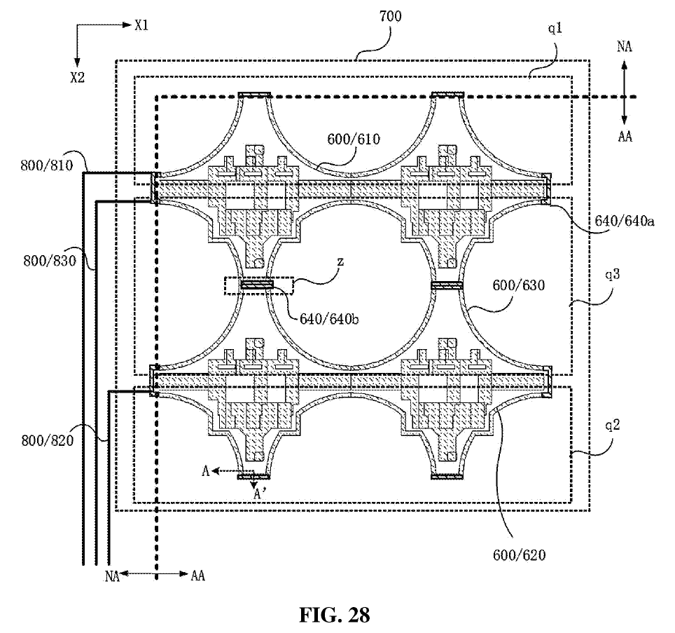

FIG. 27 is a schematic structural diagram of a second display panel provided in an embodiment of the present disclosure, and FIG. 28 is a schematic structural diagram of a first temperature sensing sub-region provided in an embodiment of the present disclosure. Referring to FIG. 1, FIG. 6, FIG. 27 and FIG. 28, the display panel 10 includes multiple temperature sensing sub-regions 700, and the temperature sensing sub-region 700 includes multiple temperature sensing units 600. The display panel 10 further includes multiple sensing signal lines 800 and a control unit 900. The multiple sensing signal lines 800 include a first voltage signal line 810, a second voltage signal line 820, and at least one temperature sensing signal line 830. The first voltage signal line 810, the second voltage signal line 820, and the temperature sensing signal line 830 are all electrically connected to the control unit 900. The temperature sensing sub-region 700 includes a first temperature sensing unit 610, a second temperature sensing unit 620 and at least one third temperature sensing unit 630 which are connected. In the same temperature sensing sub-region 700, the first temperature sensing unit 610 is electrically connected to the first voltage signal line 810, the second temperature sensing unit 620 is electrically connected to the second voltage signal line 820, and the third temperature sensing unit 630 is electrically connected to the temperature sensing signal line 830. The display panel 10 further includes a data signal line DATA, and the data signal line DATA is electrically connected to the control unit 900. The control unit 900 is configured to adjust a data signal in the data signal line DATA according to a first voltage in the first voltage signal line 810, a second voltage in the second voltage signal line 820 and a temperature sensing signal in the temperature sensing signal line 830.

In one or more embodiments, with reference to FIG. 27, the display panel 10 includes multiple temperature sensing sub-regions 700, and the display panel 10 may be more finely sensed through the multiple temperature sensing sub-regions 700. In one or more embodiments, with reference to FIG. 28, multiple temperature sensing units 600 are included in a temperature sensing sub-region 700. For the wiring and circuit settings around the temperature sensing units 600, reference may be made to FIG. 6. The specific number of temperature sensing sub-regions 700 in the display panel 10 may be adaptively adjusted according to practical requirements, and the embodiment of the present disclosure does not specifically limit this.

Further, referring to FIG. 27, the display panel 10 further includes multiple sensing signal lines 800 and a control unit 900, and the sensing signal lines 800 are used to electrically connect the temperature sensing units 600 to the control unit 900. The control unit 900 may be a driving chip or a flexible circuit board; that is, the control unit 900 is a device with computing capabilities. The control unit 900 can determine the current temperature state of the display panel 10 according to the voltage change value of the temperature sensing units 600, and then can perform gamma debugging on the light-emitting elements in the display panel 10 to ensure the overall display effect of the display panel 10.

In one or more embodiments, referring to FIG. 28, the temperature sensing sub-region 700 includes connected first temperature sensing unit 610, second temperature sensing unit 620 and at least one third temperature sensing unit 630. As shown in FIG. 28, the temperature sensing unit 600 in the q1 region is a first temperature sensing unit 610, the temperature sensing unit 600 in the q2 region is a second temperature sensing unit 620, and the temperature sensing unit 600 in the q3 region is a third temperature sensing unit 630. The division of q1, q2, and q3 is diverse. The number of the third temperature sensing units 630 may be adaptively adjusted according to practical conditions.

The sensing signal line 800 includes a first voltage signal line 810 and a second voltage signal line 820. In the same temperature sensing sub-region 700, the first temperature sensing unit 610 is electrically connected to the first voltage signal line 810, and the second temperature sensing unit 620 is electrically connected to the second voltage signal line 820. The first voltage signal line 810 and the second voltage signal line 820 are both electrically connected to the control unit 900. The control unit 900 can provide a fixed voltage value to the first voltage signal line 810, and the control unit 900 can receive the voltage value of the second voltage signal line 820. The control unit 900 can determine the temperature value in the temperature sensing sub-region 700 according to the voltage difference between the first voltage signal line 810 and the second voltage signal line 820. The multiple sensing signal lines 800 further include at least one temperature sensing signal line 830, the third temperature sensing unit 630 is electrically connected to the temperature sensing signal line 830, and the temperature sensing signal line 830 is also electrically connected to the control unit 900. The control unit can determine the temperature value of a part of the temperature sensing sub-region 700 according to the difference between the signal in the first voltage signal line 810 and the signal in the temperature sensing signal line 830.

In one or more embodiments, referring to FIGS. 27 and 28, the control unit 900 can determine the temperature value of the entire temperature sensing sub-region 700 in conjunction with the voltage difference between the first voltage signal line 810 and the second voltage signal line 820; and the control unit 900 can determine the temperature values of the first temperature sensing unit 610 and the third temperature sensing unit 630 in the temperature sensing sub-region 700 in conjunction with the voltage difference between the first voltage signal line 810 and the temperature sensing signal line 830. In this regard, the temperature sensing signal line 830 may be understood as an intermediate line set between the first voltage signal line 810 and the second voltage signal line 820, and can detect the temperature of the intermediate region between the first temperature sensing unit 610 and the second temperature sensing unit 620.

Further, in a case where the temperature sensing sub-region 700 may include multiple temperature sensing units 600, in FIG. 27, one temperature sensing sub-region 700 is connected to a first voltage signal line 810 and a second voltage signal line 820, and multiple temperature sensing signal lines 830 are set between the first voltage signal line 810 and the second voltage signal line 820. In one or more embodiments, in a case where the temperature sensing sub-region 700 may include multiple temperature sensing units 600, each temperature sensing sub-region 700 may include only one first voltage signal line 810 and one second voltage signal line 820, and the temperature of the entire temperature sensing sub-region 700 is determined based on the signals in the first voltage signal line 810 and one second voltage signal line 820.

Further, referring to FIG. 6, the display panel 10 further includes multiple data signal lines DATA, and the data signal lines DATA are also electrically connected to the control unit 900. The control unit 900 can adaptively adjust the data signal provided to the data signal line DATA according to the variation of temperature, to ensure that the pixel circuit 111 better drives the light-emitting element to emit light for display. In one or more embodiments, the control unit 900 is configured to adjust the data signal in the data signal line DATA according to the first voltage in the first voltage signal line 810, the second voltage in the second voltage signal line 820, and the temperature sensing signal in the temperature sensing signal line 830. In other words, the control unit 900 can adaptively adjust the data signal provided to the data signal line DATA according to the temperature value sensed by the temperature sensing unit 600, thereby effectively offsetting the color deviation of the light-emitting element caused by the temperature, and ensuring the overall display effect of the display panel 10.

Further, referring to FIG. 1, FIG. 14, FIG. 21 and FIG. 27, the display panel 10 further includes a first light-emitting element and a second light-emitting element, the first light-emitting element is electrically connected to the first pixel circuit 111a, and the second light-emitting element is electrically connected to the second pixel circuit 111b. The data signal line DATA includes a first data signal line DATA1 and a second data signal line DATA2, the first data signal line DATA1 is electrically connected to the first pixel circuit 111a, and the second data signal line DATA2 is electrically connected to the second pixel circuit 111b. The one, whose light-emitting efficiency variation with temperature has a larger amplitude, of the first light-emitting element and the second light-emitting element corresponds to a data signal line DATA in which the data signal has a larger amplitude of variation.

In one or more embodiments, the display panel 10 includes a first light-emitting element electrically connected to the first pixel circuit 111a, and the display panel 10 further includes a second light-emitting element electrically connected to the second pixel circuit 111b, and the first light-emitting element and the second light-emitting element have different light-emitting colors, thereby realizing the color display effect of the display panel 10. In one or more embodiments, the first light-emitting element may be a red light-emitting element or a blue light-emitting element, and the second light-emitting element may be a green light-emitting element.

Further, the data signal line DATA includes a first data signal line DATA1 and a second data signal line DATA2. The first data signal line DATA1 is electrically connected to the first pixel circuit 111a, and the second data signal line DATA2 is electrically connected to the second pixel circuit 111b. Since the first pixel circuit 111a and the second pixel circuit 111b are connected to light-emitting elements of different light-emitting colors, the control unit 900 provides different signal values to the first data signal line DATA1 and the second data signal line DATA2 with reference to the light-emitting conditions of the light-emitting elements of different colors.

In one or more embodiments, for light-emitting elements of different colors, the variation amplitudes of their light-emitting efficiencies with temperature are different. The one, whose light-emitting efficiency variation with temperature has a larger amplitude, of the first light-emitting element and the second light-emitting element corresponds to a data signal line DATA in which the data signal has a larger amplitude of variation. In one or more embodiments, if the variation amplitude of the light-emitting efficiency of the first light-emitting element with temperature is greater than the variation amplitude of the light-emitting efficiency of the second light-emitting element with temperature, the control unit 900 can adjust the variation amplitude of the first data signal line DATA1 to be greater than the variation amplitude of the second data signal line DATA2, thereby ensuring the overall display balance of the display panel 10. In one or more embodiments, the variation amplitude of the data signal in the data signal line corresponding to the first light-emitting element is greater than the variation amplitude of the data signal in the data signal line corresponding to the second light-emitting element. The first light-emitting element may be considered as a red light-emitting element, and the second light-emitting element may be considered as a green light-emitting element or a blue light-emitting element.

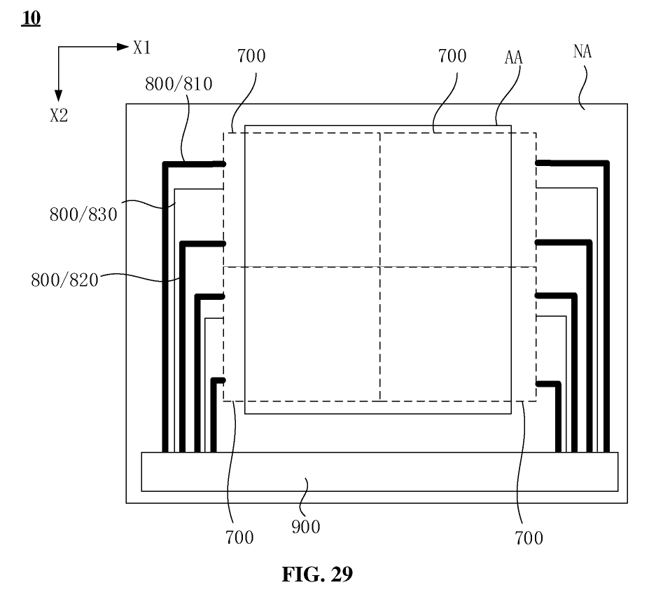

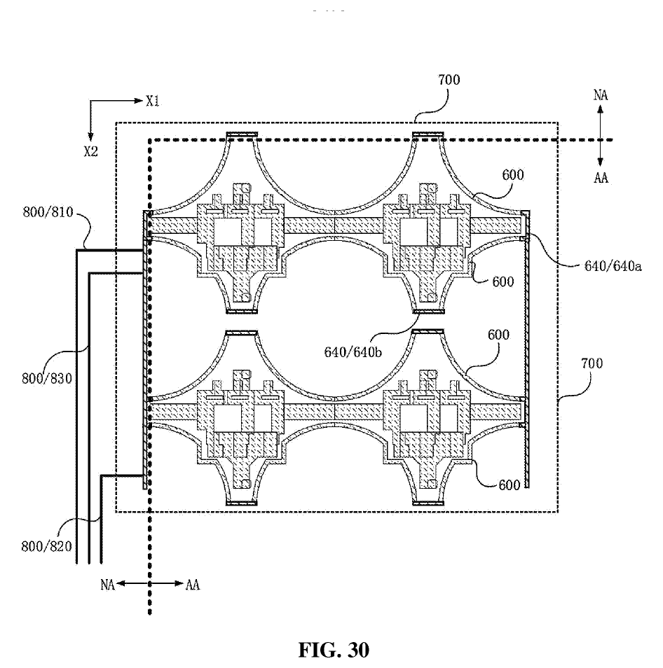

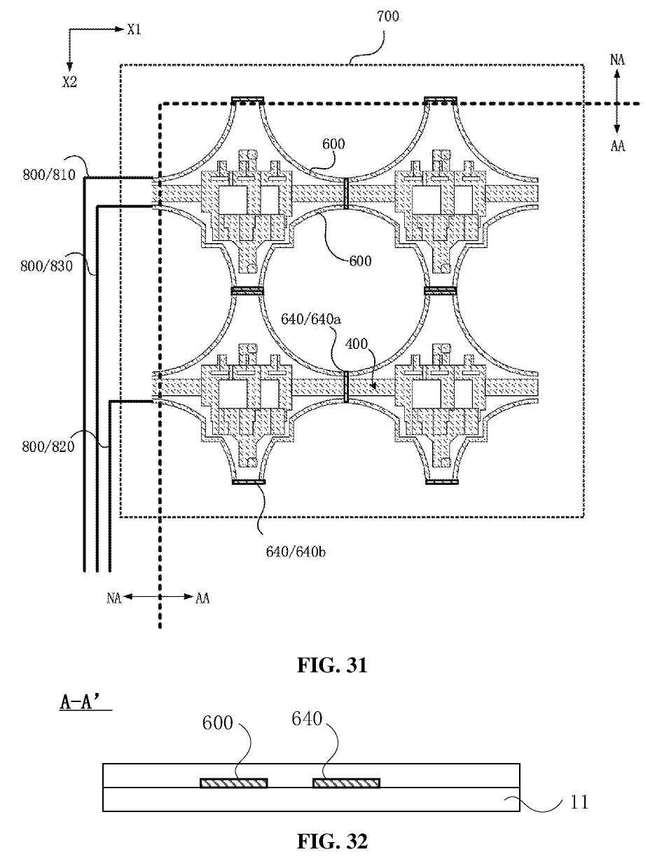

FIG. 29 is a schematic structural diagram of a third display panel provided in an embodiment of the present disclosure, FIG. 30 is a schematic structural diagram of a second temperature sensing sub-region provided in an embodiment of the present disclosure, and FIG. 31 is a schematic structural diagram of a third temperature sensing sub-region provided in an embodiment of the present disclosure. Referring to FIGS. 28 to 31, the display panel 10 includes multiple temperature sensing sub-regions 700, and the temperature sensing sub-region 700 includes multiple temperature sensing units 600; and multiple temperature sensing units 600 in the same temperature sensing sub-region 700 are electrically connected.

In one or more embodiments, the display panel 10 may include multiple temperature sensing sub-regions 700, and FIG. 27 shows two temperature sensing sub-regions 700 as an example for illustration.

Further, referring to FIGS. 28, 30 and 31, in the same temperature sensing sub-region 700, multiple temperature sensing units 600 are electrically connected, so that the sensing signal lines 800 electrically connected to the same temperature sensing sub-region 700 can transmit the electrical signals to the control unit 900, so that the control unit 900 can detect the temperature of the temperature sensing sub-region 700 and realize the brightness compensation for the corresponding light-emitting elements. In one or more embodiments, referring to FIGS. 28, 30, and 31, in a case where the temperature sensing sub-region 700 includes multiple temperature sensing units 600 arranged in the second direction X2, they are electrically connected; referring to region Z in FIG. 28, if the temperature sensing unit 600 has segmented wires extending in the first direction X1, the segmented wires are also electrically connected.

Continuing to refer to FIG. 28, FIG. 30 and FIG. 31, the display panel 10 further includes temperature sensing unit connection portions 640, and the temperature sensing unit connection portions 640 connect multiple temperature sensing units 600 in the same temperature sensing sub-region 700. The display panel 10 further includes a display region AA and a bezel region NA, and the bezel region NA surrounds at least part of the display region AA. The circuit setting regions 100a and the light-transmitting regions 100b are located in the display region AA. A temperature sensing unit connection portion 640, located in the bezel region NA, exists and/or a temperature sensing unit connection portion 640, located in the display region AA, exists.

Further, the display panel 10 further includes a temperature sensing unit connection portion 640, through which the electrical connection of adjacent temperature sensing units 600 may be achieved. Referring to FIG. 28, FIG. 30 and FIG. 31, the temperature sensing unit connection portion 640 may include temperature sensing unit connection portions 640 (shown as 640b in the figure) extending in the first direction X1, and the temperature sensing unit connection portions 640 (shown as 640b in the figure) may electrically connect the temperature sensing units 600 arranged in segments in the first direction X1. Referring to FIG. 26, FIG. 30 and FIG. 31, the temperature sensing unit connection portion 640 may include temperature sensing unit connection portions 640 (shown as 640a in the figure) extending in the second direction X2, and the temperature sensing unit connection portions 640 (shown as 640a in the figure) may electrically connect the temperature sensing units 600 arranged in segments in the second direction X2.

Further, referring to FIG. 27 to FIG. 31, the display panel 10 further includes a display region AA and a bezel region NA, and the bezel region NA surrounds at least part of the display region AA. The specific arrangement of the bezel region NA and the display region AA may be adaptively adjusted according to different display panels 10. The circuit setting regions 100a and the light-transmitting regions 100b are located in the display region AA, so that the display region AA can realize the display effect and light-transmitting effect of the display panel 10. The control unit 900 and the like may be set in the bezel region NA.

Further, referring to FIGS. 28, 30, and 31, part of the temperature sensing unit connection portions 640 included in the display panel 10 may be located in the bezel region NA, which can avoid the wires occupying too much display region AA and increase the space share of the display region AA in the display panel 10. Referring to FIGS. 28, 30, and 31, part of the temperature sensing unit connection portions 640 included in the display panel 10 may be located in the display region AA, ensuring that the adjacent temperature sensing units 600 can realize the transmission of electrical signals with a smaller path, and ensuring the temperature detection effect of the temperature sensing sub-region 700. Therefore, some temperature sensing unit connection portions 640 may be set in the display region AA, some temperature sensing unit connection portions 640 may be set in the bezel region NA, and the temperature sensing unit connection portions 640 may be set in the display region AA and the bezel region NA. This shows that the setting of the temperature sensing unit connection portions 640 is flexible, and their setting positions may be adaptively adjusted according to requirements.

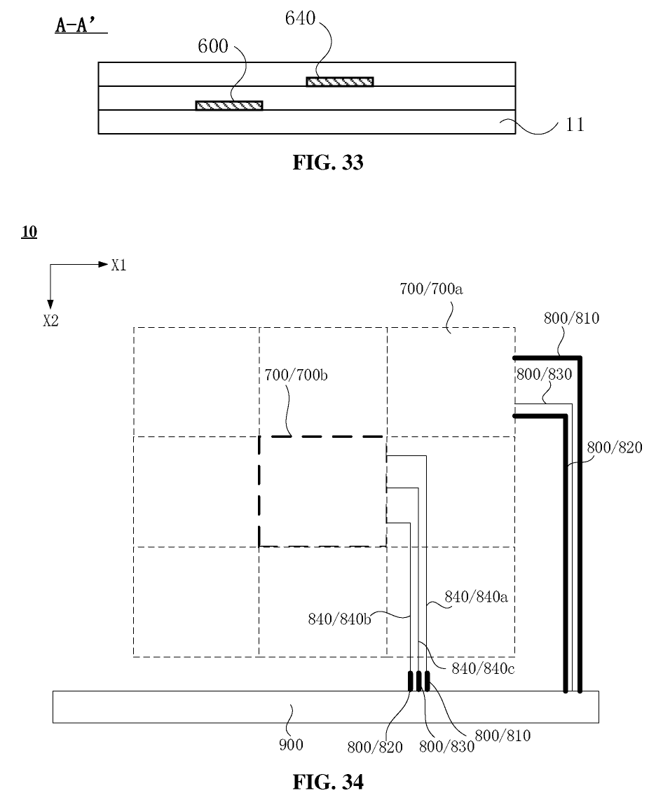

FIG. 32 is a first schematic diagram of the A-A’ section in FIG. 28, and FIG. 33 is a second schematic diagram of the A-A’ section in FIG. 28. Referring to FIG. 5, FIG. 7, FIG. 28, and FIG. 30 to FIG. 33, the display panel 10 further includes temperature sensing unit connection portions 640, and the temperature sensing unit connection portions 640 connect multiple temperature sensing units 600 in the same temperature sensing sub-region 700. A temperature sensing unit connection portion 640, arranged in the same layer as the temperature sensing units 600, exists; and/or a temperature sensing unit connection portion 640, arranged in a different layer from the temperature sensing units 600, exists.

Further, referring to FIG. 5, the temperature sensing units 600 may be arranged in the film layer where the light-shielding metal layer 12 is located. Further, referring to FIG. 28 and FIG. 32, the temperature sensing unit connection portions 640 for electrically connecting adjacent temperature sensing units 600 may be arranged in the same layer as the temperature sensing units 600, so that the temperature sensing unit connection portions 640 and the temperature sensing units 600 may be prepared synchronously, reducing the process preparation cost of the display panel 10, and arranging multiple film layer structures in the same layer is also conducive to realizing the thin design of the display panel 10. Further, referring to FIG. 28 and FIG. 32, the temperature sensing unit connection portions 640 for electrically connecting adjacent temperature sensing units 600 may also be arranged in a different layer from the temperature sensing units 600. This shows that the setting position of the temperature sensing unit connection portions 640 is flexible. Further, referring to FIG. 31, for the temperature sensing unit connection portion 640 extending in the second direction X2 (the temperature sensing unit connection portion 640a in FIG. 31), to connect two adjacent temperature sensing units 600, the temperature sensing unit connection portion 640 needs to be arranged across layers with the temperature sensing units 600 to avoid short circuit with the light-shielding structure 400 arranged on the light-shielding metal layer 12, to ensure the stability of transmission of signals. In this case, the temperature sensing unit connection portion 640 extending in the second direction X2 (the temperature sensing unit connection portion 640a in FIG. 31) may be arranged in the film layer where the second metal layer 15 is located.

Continuing to refer to FIGS. 27 to 31, the display panel 10 includes multiple temperature sensing sub-regions 700, and a temperature sensing sub-region 700 includes multiple temperature sensing units 600. The display panel 10 further includes multiple sensing signal lines 800 and a control unit 900, and the multiple sensing signal lines 800 include a first voltage signal line 810, a second voltage signal line 820, and at least one temperature sensing signal line 830. The first voltage signal line 810, the second voltage signal line 820, and the temperature sensing signal line 830 are all electrically connected to the control unit 900. The display panel 10 further includes a display region AA and a bezel region NA, and the bezel region NA surrounds at least part of the display region AA. The circuit setting regions 100a and the light-transmitting regions 100b are located in the display region AA. The first voltage signal line 810, the second voltage signal line 820, and the at least one temperature sensing signal line 830 are located in the bezel region NA.

Further, referring to FIGS. 27 to 31, the sensing signal lines 800 for electrically connecting the temperature sensing units 600 to the control unit 900 may be set in the bezel region NA to avoid the sensing signal lines 800 occupying too much space in the display region AA, affecting the space of the light-transmitting region 100b in the display region AA, or affecting the number of light-emitting elements set in the display region AA, to better ensure the display effect and light-transmitting effect of the display panel 10. Referring to FIGS. 27 to 31, the first voltage signal lines 810, the second voltage signal lines 820, and the temperature sensing signal lines 830 are all located in the bezel region NA.

FIG. 34 is a schematic structural diagram of a fourth display panel provided in an embodiment of the present disclosure. Referring to FIG. 34, the display panel 10 further includes a signal line connection portion 840, at least part of the signal line connection portion 840 is located in the display region AA. The temperature sensing units 600 in at least one temperature sensing sub-region 700 are electrically connected to the first voltage signal line 810, the second voltage signal line 820 and at least one temperature sensing signal line 830 through the signal line connection portion 840.

Further, referring to FIG. 34, in a case where the display panel 10 includes multiple temperature sensing sub-regions 700, some of the temperature sensing sub-regions 700 are close to the bezel region NA of the display panel 10, for example, the temperature sensing sub-region 700 in FIG. 34 (shown as 700a in FIG. 34), and at least some of the temperature sensing sub-regions 700 are close to the inside of the display region AA of the display panel 10 (shown as 700b in FIG. 34).

In one or more embodiments, the temperature sensing sub-region 700 close to the bezel region NA of the display panel 10 may be electrically connected to the control unit 900 through the sensing signal lines 800 shown in FIG. 34. The temperature sensing sub-region 700 located in the central region of the display panel 10 may be electrically connected to the sensing signal lines 800 through a signal line connection portion 840 provided in the display region AA, and then electrically connected to the control unit 900 through the sensing signal lines 800.

Further, referring to FIG. 34, the signal line connection portion 840 may include a first signal line connection portion 840a, a second signal line connection portion 840b and at least one third signal line connection portion 840c. In one or more embodiments, the first signal line connection portion 840a is electrically connected to the first voltage signal line 810, and then electrically connected to the control unit 900. The second signal line connection portion 840b is electrically connected to the second voltage signal line 820, and then electrically connected to the control unit 900. The third signal line connection portion 840c is electrically connected to the temperature sensing signal line 830, and then electrically connected to the control unit 900.

Further, referring to FIG. 6, the sheet resistance of the temperature sensing unit 600 is greater than or equal to the sheet resistance of the signal line 500.

In one or more embodiments, referring to FIG. 6, the sheet resistance of the temperature sensing unit 600 may be greater than or equal to the sheet resistance of the signal line 500, so as to ensure that the temperature sensing unit 600 generates a relatively obvious signal variation amplitude when the temperature changes.

In one or more embodiments, the signal line 500 may include a reset signal line VREF, and the reset signal line VREF includes a first reset sub-portion VREFa located in the second metal layer 15 and a second reset sub-portion VREFb located in the third metal layer 16. The sheet resistance of the temperature sensing unit 600 may be equal to the sheet resistance of the metal wire provided on the second metal layer 15, or equal to the sheet resistance of the metal wire provided on the third metal layer 16.

In one or more embodiments, the signal line 500 may further be the first scanning signal line SCAN1, the second scanning signal line SCAN2, or the light-emitting control signal line EMIT located in the first metal layer 14, and the sheet resistance of the temperature sensing unit 600 may be greater than the sheet resistance of the metal wire provided on the first metal layer 14.

Referring to FIGS. 5, 6, 7, 8, 9, 14, 23 and 24, the light-emitting control transistor T6 and/or the anode reset transistor T7 include an active layer, and the active layer includes a channel region. The display panel 10 further includes a substrate 11 and a light-shielding structure 400, and the light-shielding structure 400 is located in the circuit setting region 100a and is located on a side of the pixel circuit 111 close to the substrate 11. In the direction perpendicular to the plane where the substrate 11 is located, the light-shielding structure 400 overlaps at least part of the channel region of the transistor; and the temperature sensing units 600 are arranged in the same layer as the light-shielding structure 400.

The light-shielding structure 400 may be arranged in the film layer where the light-shielding metal layer 12 is located. The light-shielding structure 400 has the effect of shielding light and can prevent light from passing through. In one or more embodiments, in the thickness direction of the display panel 10, the light-shielding structure 400 overlaps at least part of the channel region, and the light-shielding structure 400 can effectively avoid the situation where light is irradiated to the channel region to generate light leakage, thereby ensuring the working stability of the corresponding transistors.

The temperature sensing unit 600 may be arranged in the same layer as the light-shielding structure 400. As shown in FIG. 7, the temperature sensing unit 600 and the light-shielding structure 400 are both arranged in the film layer where the light-shielding metal layer 12 is located. The temperature sensing unit 600 is arranged in the existing film layer, which, in one aspect, can reduce the film layer thickness of the display panel 10 and is conducive to realizing the thin design of the display panel 10, and in another aspect, can prepare the temperature sensing unit 600 and the light-shielding structure 400 simultaneously, and reduce the process preparation cost of the display panel 10.

Continuing to refer to FIG. 2, FIG. 5 to FIG. 13, the light-emitting control transistor T6 and/or the anode reset transistor T7 include an active layer. The pixel circuit 111 further includes a storage capacitor Cst, the storage capacitor Cst includes a first electrode plate C1 and a second electrode plate C2 that are arranged opposite to each other, and the second electrode plate C2 is located on the side of the first electrode plate C1 away from the active layer. The display panel 10 further includes a first scanning signal line SCAN1, a second scanning signal line SCAN2, a light-emitting control signal line EMIT, a reset signal line VREF, a data signal line DATA, a first power signal line PVDD and a second power signal line PVEE. The reset signal line VREF includes a first reset sub-portion VREFa and a second reset sub-portion VREFb, specifically, the first reset sub-portion VREFa is arranged in a different layer from the second reset sub-portion VREFb and is electrically connected to the second reset sub-portion VREFb. The display panel 10 further includes a first semiconductor layer 13, a first metal layer 14, a second metal layer 15, a third metal layer 16, a fourth metal layer 17 and a fifth metal layer 18 which are stacked. The active layer is located in the first semiconductor layer 13. The first electrode plate C1 and the first scanning signal line SCAN1, the second scanning signal line SCAN2 and the light-emitting control signal line EMIT are all located in the first metal layer 14. The second electrode plate C2 and the first reset sub-portion VREFa are all located in the second metal layer 15. The data signal line DATA and the second reset sub-portion VREFb are all located in the third metal layer 16. The first power signal line PVDD is located in the fourth metal layer 17. The second power signal line PVEE is located in the fifth metal layer 18.

In one or more embodiments, referring to FIGS. 5, 6, 8, 9, and FIG. 14, the light-emitting control transistor T6 and/or the anode reset transistor T7 include an active layer, the transistor region shown correspondingly in FIG. 8 may be understood as the corresponding active layer, and the active layer is arranged in the first semiconductor layer 13. The active layer further includes a channel region. In combination with FIG. 8, FIG. 9, and FIG. 14, the channel region of the active layer may be understood as: in the thickness direction of the display panel 10, the region where wires of the first metal layer 14 overlap the corresponding active layer.

Referring to FIG. 2, the pixel circuit 111 may further include multiple transistors, such as a power signal writing transistor T1, a data writing transistor T2, a driving transistor T3, a threshold compensation transistor T4, and an initialization transistor T5. The pixel circuit 111 further includes a storage capacitor Cst, and the storage capacitor Cst includes a first electrode plate C1 and a second electrode plate C2. Therefore, the setting methods of the pixel circuit 111 are diverse, and the transistors may be increased or decreased according to the requirements.

The display panel 10 further includes multiple wires, such as a first scanning signal line SCAN1, a second scanning signal line SCAN2, a light-emitting control signal line EMIT, a reset signal line VREF, a data signal line DATA, a first power signal line PVDD and a second power signal line PVEE, etc., which are electrically connected to the pixel circuit 111 or the light-emitting element 2000 respectively. Some wires are each arranged in two layers, for example, the reset signal line VREF includes a first reset sub-portion VREFa and a second reset sub-portion VREFb arranged in different layers and electrically connected.

In one or more embodiments, referring to FIGS. 5 to 16, the first electrode plate C1 and the first scanning signal line SCAN1, the second scanning signal line SCAN2 and the light-emitting control signal line EMIT are arranged in the same layer, all located in the first metal layer 14. The second electrode plate C2 and the first reset sub-portion VREFa are arranged in the same layer, all located in the second metal layer 15. The data signal line DATA and the second reset sub-portion VREFb are arranged in the same layer, both located in the third metal layer 16. The first power signal line PVDD is located in the fourth metal layer 17. The second power signal line PVEE is located in the fifth metal layer 18.

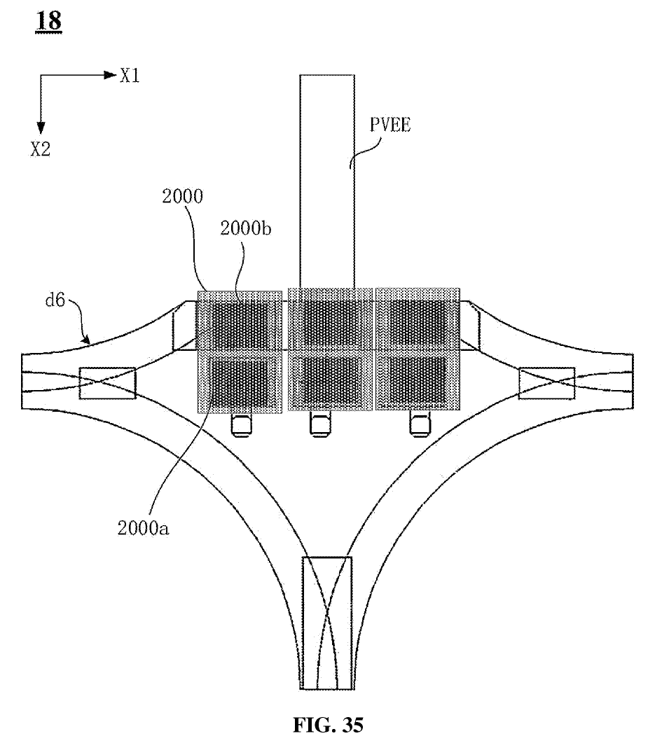

FIG. 35 is a schematic diagram showing a partial structure of a display panel provided in an embodiment of the present disclosure. Referring to FIG. 2, FIG. 5, FIG. 6, FIG. 12, FIG. 14, and FIG. 35, the display panel 10 further includes a light-emitting element 2000, and the light-emitting element 2000 includes a first electrode 2000a. The display panel 10 further includes a first electrode pad 2000c and a pad connection portion 2000d, and the first electrode pad 2000c connects the first electrode 2000a and the pad connection portion 2000d. The first electrode pad 2000c is located in the fifth metal layer 18, and the pad connection portion 2000d is located in the fourth metal layer 17.

The display panel 10 further includes a light-emitting element 2000, and the light-emitting element 2000 is electrically connected to the pixel circuit 111. The pixel circuit 111 can drive the light-emitting element 2000 to perform light-emitting display, thereby realizing the display effect of the display panel 10. In one or more embodiments, referring to FIG. 2, the light-emitting control transistor T6 included in the pixel circuit 111 is electrically connected to the light-emitting element 100.

The light-emitting element 2000 includes a first electrode 2000a, and the light-emitting control transistor T6 is electrically connected to the first electrode 2000a, so that the pixel circuit 111 drives the light-emitting element 2000 to emit light. In one or more embodiments, referring to FIG. 6, FIG. 11, and FIG. 12, the light-emitting control transistor T6 is electrically connected to the pad connection portion 2000d (refer to the via f1 in FIG. 12). Then the pad connection portion 2000d is electrically connected to the first electrode pad 2000c. Referring to FIG. 34, the first electrode 2000a of the light-emitting element 2000 is electrically connected to the first electrode pad 2000c, so that the first electrode 2000a of the light-emitting element 2000 is electrically connected to the light-emitting control transistor T6.

Further, in combination with FIGS. 5, 6, and FIG. 12, the pad connection portion 2000d may be arranged in the film layer where the fourth metal layer 17 is located, and the pad connection portion 2000d may be arranged in the same layer as the first power signal line PVDD. The first power signal line PVDD is electrically connected to the data writing transistor T2 in the pixel circuit 111 through a via (via f2 in FIG. 12).

Further, with reference to FIGS. 5, 6, 12, 13 and 35, the first electrode pad 2000c may be arranged in the film layer where the fifth metal layer 18 is located, and the first electrode pad 2000c is arranged in the same layer as the second power signal line PVEE. In one or more embodiments, the first electrode 2000a of the light-emitting element 2000 is electrically connected to the first electrode pad 2000c, and the second electrode 2000b of the light-emitting element 2000 is electrically connected to the second power signal line PVEE, so that the light-emitting element 2000 realizes its light emission according to the signals received by the first electrode 2000a and the second electrode 2000b, thereby realizing the display function of the display panel 10.

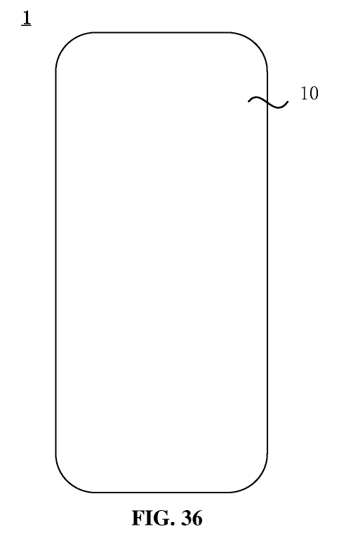

Based on the same inventive concept, a display device is further provided according to embodiments of the present disclosure. FIG. 36 is a schematic structural diagram of a display device provided in an embodiment of the present disclosure. As shown in FIG. 36, the display device 1 includes a display panel 10 described in any of the above embodiments. Therefore, the display device 1 provided in the embodiments of the present disclosure has the corresponding beneficial effects in the above embodiments, which will not be repeated here. The display device 1 may be an electronic device such as a mobile phone, a computer, a smart wearable apparatus (for example, a smart watch), or a vehicle-mounted display device.

It should be noted that the above are only preferred embodiments of the present disclosure and the technical principles used. The person skilled in the art will understand that the present disclosure is not limited to the specific embodiments described here, and that various obvious variations, readjustments, and substitutions may be made for the person skilled in the art without departing from the scope of protection of the present disclosure. Therefore, although the present disclosure is described in more detail through the above embodiments, the present disclosure is not limited to the above embodiments, and may include other equivalent embodiments without departing from the concept of the present disclosure, and the scope of the present disclosure is determined by the scope of the attached claims.

What is claimed is:

1. A display panel, comprising:
a plurality of circuit setting regions and a plurality of light-transmitting regions, wherein a circuit setting region of the plurality of circuit setting regions partially surrounds a light-transmitting region of the plurality of light-transmitting regions;
the display panel further comprises a pixel circuit group located in the circuit setting region, wherein the pixel circuit group comprises at least two pixel circuits, wherein the at least two pixel circuits comprise a first pixel circuit and a second pixel circuit, wherein the first pixel circuit is located on a side of the second pixel circuit close to the light-transmitting region in a first direction;
a pixel circuit of at least two pixel circuits comprises a light-emitting control transistor and an anode reset transistor, the first pixel circuit comprises a first light-emitting control transistor and a first anode reset transistor, and the second pixel circuit comprises a second light-emitting control transistor; and
in a same pixel circuit group, a first anode reset transistor is located on a side of the first light-emitting control transistor close to the second light-emitting control transistor in the first direction.

2. The display panel according to claim 1, wherein the first anode reset transistor does not overlap the first light-emitting control transistor in a second direction, and the second direction intersects the first direction.

3. The display panel according to claim 1, wherein in a same pixel circuit group, the first anode reset transistor overlaps the second light-emitting control transistor in a second direction, and the second direction intersects the first direction.

4. The display panel according to claim 1, wherein the at least two pixel circuits further comprise a third pixel circuit, and the first pixel circuit, the second pixel circuit and the third pixel circuit are arranged in the first direction;
the third pixel circuit comprises a third light-emitting control transistor and a third anode reset transistor; and
in a same pixel circuit group, the third anode reset transistor is located on a side of the third light-emitting control transistor close to the second light-emitting control transistor in the first direction.

5. The display panel according to claim 1, wherein the second pixel circuit further comprises a second anode reset transistor;
the display panel further comprises a reset signal line, the reset signal line comprises a first reset sub-portion, at least part of the first reset sub-portion extends in a second direction, and the second direction intersects the first direction; and
the first anode reset transistor and the second anode reset transistor in a same pixel circuit group are electrically connected to a same first reset sub-portion.

6. The display panel according to claim 5, further comprising an anode reset connection portion, wherein a same anode reset connection portion is electrically connected to the first anode reset transistor through a first connection via, is electrically connected to the second anode reset transistor through a second connection via, and is electrically connected to the first reset sub-portion through a connection via.

7. The display panel according to claim 5, wherein the reset signal line further comprises a second reset sub-portion, the second reset sub-portion is arranged in a different layer from the first reset sub-portion and is electrically connected to the first reset sub-portion;
the pixel circuit comprises an initialization transistor, the first pixel circuit further comprises a first initialization transistor, and the second pixel circuit further comprises a second initialization transistor; and
the first initialization transistor is electrically connected to the second reset sub-portion, and the second initialization transistor is electrically connected to the first reset sub-portion.

8. The display panel according to claim 1, further comprising a plurality of data signal line groups, wherein a data signal line group of the plurality of data signal line groups comprises a first data signal line and a second data signal line, the first data signal line is electrically connected to the first pixel circuit, and the second data signal line is electrically connected to the second pixel circuit;
the first data signal line comprises a first data segment, a second data segment, and a third data segment, the second data segment connects the first data segment and the third data segment, the first data segment and the third data segment extend in the second direction, and at least part of the second data segment extends in the first direction;
the second data signal line comprises a fourth data segment, a fifth data segment, and a sixth data segment, the fifth data segment connects the fourth data segment and the sixth data segment, the fourth data segment and the sixth data segment extend in a second direction, and at least part of the fifth data segment extends in the first direction;
the display panel further comprises a wiring region, the wiring region is located between two light-transmitting regions arranged in the second direction, and the second direction intersects the first direction;
the first data segment and the fourth data segment both overlap the light-transmitting region, and the third data segment and the sixth data segment both overlap the wiring region; and
in a same data signal line group, in the first direction, a distance between the first data segment and the fourth data segment is less than or equal to a distance between the third data segment and the sixth data segment.

9. The display panel according to claim 8, wherein at least one of the light-emitting control transistor or the anode reset transistor comprises an active layer, and the active layer comprises a channel region;
the display panel further comprises a substrate and a light-shielding structure, and the light-shielding structure is located in the circuit setting region and on a side of the active layer close to the substrate; and
in a direction perpendicular to a plane where the substrate is located, the light-shielding structure overlaps at least part of the channel region.

10. The display panel according to claim 9, further comprising a light-shielding connection structure, wherein the light-shielding connection structure is configured to connect two light-shielding structures adjacently arranged in the second direction, and the light-shielding connection structure is electrically connected to a fixed potential signal line; and
in the first direction, the light-shielding connection structure is located between the first data segment and the fourth data segment.

11. The display panel according to claim 1, further comprising a signal line, wherein the signal line is electrically connected to the pixel circuit; and
an edge of the signal line on a side close to the light-transmitting region comprises a non-straight line.

12. The display panel according to claim 11, wherein the edge of the signal line on the side close to the light-transmitting region comprises a curve; and
the curve has a fixed radius of curvature.

13. The display panel according to claim 11, further comprising a first scanning signal line, a second scanning signal line and a light-emitting control signal line, wherein
the pixel circuit further comprises an initialization transistor and a data writing transistor; a control terminal of the initialization transistor and a control terminal of the anode reset transistor are both electrically connected to the first scanning signal line, a control terminal of the data writing transistor is electrically connected to the second scanning signal line, and a control terminal of the light-emitting control transistor is electrically connected to the light-emitting control signal line; and
the signal line comprises at least one of the first scanning signal line, the second scanning signal line or the light-emitting control signal line.

14. The display panel according to claim 13, wherein the circuit setting regions are arranged in the first direction into a circuit setting region row, circuit setting region rows are arranged in a second direction, and the second direction intersects the first direction;
a plurality of circuit setting region rows comprise a first circuit setting region row and a second circuit setting region row adjacently arranged in the second direction;
the first scanning signal line comprises a first scanning sub-portion, a second scanning sub-portion, and a scanning connection portion; and the first scanning sub-portion is electrically connected to control terminals of a plurality of anode reset transistors in the first circuit setting region row, the second scanning sub-portion is electrically connected to control terminals of a plurality of initialization transistors in the second circuit setting region row, and the scanning connection portion connects the first scanning sub-portion and the second scanning sub-portion; and
the signal line comprises part of the second scanning sub-portion and the scanning connection portion, and a curvature radius of the second scanning sub-portion is same as a curvature radius of the scanning connection portion.

15. The display panel according to claim 11, further comprising a reset signal line, wherein the reset signal line comprises a second reset sub-portion;
the first pixel circuit further comprises a first initialization transistor, and the first initialization transistor is electrically connected to the second reset sub-portion; and
the signal line comprises the second reset sub-portion.

16. The display panel according to claim 11, wherein the pixel circuit further comprises a power signal writing transistor;
the display panel further comprises a first power signal line, and the first power signal line is electrically connected to a first terminal of the power signal writing transistor; and
the signal line comprises the first power signal line.

17. The display panel according to claim 11, wherein at least two signal lines surrounding a same light-transmitting region comprise a first signal line and a second signal line;
the first signal line comprises a first signal line edge on a side close to the light-transmitting region, and the second signal line comprises a second signal line edge on the side close to the light-transmitting region, the first signal line edge and the second signal line edge overlap in both the first direction and the second direction, and the second direction intersects the first direction; and
any two points on the first signal line edge comprise a first point and a second point, and a minimum distance between the first point and the second signal line edge is equal to a minimum distance between the second point and the second signal line edge.

18. The display panel according to claim 11, wherein at least two signal lines surrounding a same light-transmitting region comprise a third signal line and a fourth signal line;
the third signal line comprises a third signal line edge on a side close to the light-transmitting region, and the fourth signal line comprises a fourth signal line edge on the side close to the light-transmitting region; and
in a thickness direction of the display panel, at least part of the third signal line edge overlaps at least part of the fourth signal line edge.

19. The display panel according to claim 1, wherein at least one of the light-emitting control transistor or the anode reset transistor comprises an active layer;
the pixel circuit further comprises a storage capacitor, the storage capacitor comprises a first electrode plate and a second electrode plate arranged opposite to each other, and the second electrode plate is located on a side of the first electrode plate away from the active layer;
the display panel further comprises a first scanning signal line, a second scanning signal line, a light-emitting control signal line, a reset signal line, a data signal line, a first power signal line and a second power signal line;
the reset signal line comprises a first reset sub-portion and a second reset sub-portion arranged in different layers and electrically connected;
the display panel further comprises a first semiconductor layer, a first metal layer, a second metal layer, a third metal layer, a fourth metal layer and a fifth metal layer arranged in a stacked manner;
the active layer is located in the first semiconductor layer;
the first electrode plate and the first scanning signal line, the second scanning signal line and the light-emitting control signal line are all located in the first metal layer;
the second electrode plate and the first reset sub-portion are both located in the second metal layer;
the data signal line and the second reset sub-portion are both located in the third metal layer;
the first power signal line is located in the fourth metal layer; and
the second power signal line is located in the fifth metal layer.

20. A display device, comprising a display panel, wherein the display panel comprises:
a plurality of circuit setting regions and a plurality of light-transmitting regions, wherein a circuit setting region of the plurality of circuit setting regions partially surrounds a light-transmitting region of the plurality of light-transmitting regions;
the display panel further comprises a pixel circuit group located in the circuit setting region, wherein the pixel circuit group comprises at least two pixel circuits, wherein the at least two pixel circuits comprise a first pixel circuit and a second pixel circuit, wherein the first pixel circuit is located on a side of the second pixel circuit close to the light-transmitting region in a first direction;
a pixel circuit of at least two pixel circuits comprises a light-emitting control transistor and an anode reset transistor, the first pixel circuit comprises a first light-emitting control transistor and a first anode reset transistor, and the second pixel circuit comprises a second light-emitting control transistor; and
in a same pixel circuit group, a first anode reset transistor is located on a side of the first light-emitting control transistor close to the second light-emitting control transistor in the first direction.
